(19) United States
(12) Patent Application Publication
(10) Pub. No.: US 2008/0231170 A1
(43) Pub. Date: Sep. 25, 2008

(54) Wavelength Converter, Light-Emitting Device, Method of Producing Wavelength Converter and Method of Producing Light-Emitting Device

(76) Inventors: Fukudome Masato, Kirishima-shi (JP); Shigeoka Toshiaki, Kirishima-shi (JP); Nakagawaji Fujito, Kirishima-shi (JP); Ozaki Tetsuaki, Kirishima-shi (JP)

Correspondence Address: HOGAN & HARTSON L.L.P., 1999 AVENUE OF THE STARS, SUITE 1400, LOS ANGELES, CA, 90067, US

(21) Appl. No.: 10/597,470

(22) PCT Filed: Jan. 26, 2005
(86) PCT No.: PCT/JP2005/000972

§ 371 Date: Jul. 26, 2006

(30) Foreign Application Priority Data
Jan. 26, 2004 (JP) 2004-016699

(51) Int. Cl. H01J 1/62; G03C 5/00; H01J 9/02

(52) U.S. Cl. 313/501; 430/23; 445/23

(57) ABSTRACT

A light-emitting device comprises a light-emitting element 3 that is provided on a substrate 2 and emits excitation light, and a wavelength converter 4 that converts the excitation light into visible light. The visible light is output light. The wavelength converter 4 comprises a plurality of wavelength conversion layers 4a, 4b and 4c which respectively contain, as phosphors, at least one type of semiconductor ultrafine particles having a mean particle size of not more than 20 nm and at least one type of fluorescent substance having a mean particle size of not less than 0.1 μm in a resin matrix. Thereby, self-quenching of phosphors is reduced and high luminous efficiency is attained.

### TECHNICAL FIELD

The present invention relates to a wavelength converter used for a light-emitting device and the like to wavelength-convert light emitted from a light-emitting element and take it to the outside, a light-emitting device, a method of producing a wavelength converter and a method of producing a light-emitting device. In particular, it relates to a wavelength converter suitably used for backlight power supply for electronic display, fluorescent lamps or the like, a light-emitting device, a method of producing a wavelength converter and a method of producing a light-emitting device.

### BACKGROUND ART

A light-emitting element (hereinafter, referred to also as LED chip) made of semiconductor material has small size and good power efficiency, and becomes brilliantly colored. In addition, because of its excellent characteristics such as long product life, resistance to on/off lighting repetition and low power consumption, an LED chip is expected to be applied to a backlight source of liquid crystal etc. or an illumination light source of fluorescent lamps etc.

An LED chip has already been manufactured as and applied to a light-emitting device that emits light of different color from the LED light, by wavelength-converting part of the LED chip's light with phosphors, mixing the wavelength-converted light and the LED light that is not wavelength-converted, and releasing them. Concretely, to emit white light, a light-emitting device provided with wavelength conversion layers containing phosphors on the LED chip surface has been proposed. For example, in a light-emitting device wherein wavelength conversion layers containing YAG-based phosphors represented by a composition formula of (Y,Gd)₃(Al,Ga)₅O₁₂ are formed on a blue LED chip using nGaN-based material, blue light is released from the LED chip and part of blue light turns into yellow light in the wavelength conversion layers. Thus, a light-emitting device that gives white color by mixing blue light and yellow light has been proposed (e.g. see Patent literature 1).

One example of a light-emitting device having this structure is shown in FIG. 6. In FIG. 6, a light-emitting device comprises a substrate 22 having electrodes 21 formed, an LED light-emitting element 23 on the substrate 22, emitting light with a center wavelength of 470 nm and made of semiconductor material, and a wavelength conversion layer 24 provided on the substrate 22 so as to cover the light-emitting element 23. The wavelength conversion layer 24 contains phosphors 25. If desired, a reflector 26 to reflect light can be provided on the side surfaces of the light-emitting element 23 and the wavelength conversion layer 24 to make the light running into the side surfaces focus forward and increase the intensity of output light.

In the light-emitting device, when phosphors are illuminated with light emitted from the light-emitting element 23, the phosphors are excited and emit visible light. The visible light is used as output.

However, the problem is that if brilliance of the LED light-emitting element 23 is changed, the light quantity ratio of blue to yellow changes and therefore white color tone changes, leading to poor color rendering.

To solve this problem, it has been proposed that adopting a structure where a violet LED chip having a peak of not more than 400 nm is used as an LED light-emitting element 23 in FIG. 6 and a wavelength conversion layer 24 has three types of phosphors 25 mixed in polymer resin, violet light is converted into each wavelength of red, green and blue to emit white light (e.g. see Patent literature 2).

Although the light-emitting device described in Patent literature 2 covers a wide range of emission wavelengths and therefore significantly improves color rendering, there has been the problem that luminous efficiency is lowered as a whole because the presence of three types of phosphors 25 mixed in the wavelength conversion layer 23 causes interaction between phosphors such as a red phosphor absorbing the light converted by a blue phosphor, inducing self-quenching, and the light once converted is absorbed by phosphors again. Consequently, emission intensity is not sufficient and the light-emitting device is made dark. In order to make up for this, power consumption needs to be increased.

Furthermore, such a system as described in Patent literature 3 has had the problem that the luminous efficiency (fluorescence quantum yield) of phosphors is low and in particular, the luminous efficiency of red in the range of 600 to 750 nm is low.

It has been considered that semiconductor ultrafine particles having a mean particle size of not more than 10 nm are used as phosphor to obtain high luminous efficiency in each wavelength (see Nonpatent literature 1). According to this method, if the mean particle size of semiconductor ultrafine particles is set to an appropriate value of about 10 nm, semiconductor ultrafine particles quickly repeat light absorption and light emission, and therefore, high fluorescence yield can be attained. Moreover, since energy levels are discrete and the band gap energy of semiconductor ultrafine particles change in accordance with the particle size of phosphors, various kinds of light from red (long wavelength) to blue (short wavelength) are emitted, by changing the particle size of semiconductor ultrafine particles. For example, cadmium selenide which generates fluorescence having a wavelength of 700 to 800 nm emits light of red (long wavelength) to blue (short wavelength) having high fluorescence yield, by changing its particle size in the range of 2 nm to 10 nm. Therefore, there is the expectation that this method will make it possible to produce a light-emitting device having high color rendering and good efficiency.

For example, a hot soap method (see Patent literature 3) and a microreactor method (see Patent literature 4) have been reported as a method to produce such semiconductor ultrafine particles. The use of these methods enables semiconductor ultrafine particles having a particle size of not more than 20 nm to be obtained. However, as mentioned below, there are two problems with semiconductor particles having smaller particle size. The first problem is that semiconductor particles having a particle size as small as about 20 nm ends up having a high ratio of the surface area to the volume and therefore the particle surface reacts with water, deteriorating fluorescence characteristics. In order to obtain a stable light-emitting device over a long period of time, some effort to keep phosphor particles from being exposed to moisture is needed. As a method to solve this problem, there exists a method of providing phosphors for a light-emitting device as a composite where phosphors are dispersed in a resin matrix having low water permeability. However, there is the problem that phosphors react with moisture in the process before mixing phosphors with resin and hardening them, deteriorating the characteristics of phosphors.

The second problem is the occurrence of aggregation of semiconductor ultrafine particles. Generally, as semiconductor particles have small particle size, they are apt to cause aggregation, and therefore it becomes difficult to disperse them as individual particles in a resin matrix. In the case that semiconductor particles have a diameter of over 20 nm, even if the semiconductor particles form an aggregate, the light emitted by the aggregate has the same color as the light emitted by individual particles, and it is not so necessary to worry about aggregation. However, if semiconductor ultrafine particles of not more than 20 nm aggregate, the aggregate generates fluorescence having a longer wavelength than the case as individual particles. Therefore, when there are many aggregates, it is impossible to produce a light-emitting device which stably emits light of a certain wavelength. Consequently, when producing a light-emitting device provided with a composite that contains semiconductor ultrafine particles having a particle size of not more than 20 nm in resin, as a wavelength converter, technique to disperse semiconductor ultrafine particles as individual particles in a resin matrix has been required.

To solve the second problem, the method to disperse and fix semiconductor ultrafine particles as individual particles in a polymethacrylate matrix has been reported (see Nonpatent literature 2). Also, the method to obtain a film having semiconductor ultrafine particles dispersed, by dispersing semiconductor ultrafine particles in ethanol, mixing them with polyethylene oxide paint having alcohol as a solvent and applying them, has been reported (see Patent literature 5).

However, resin conventionally used, such as polymethacrylate and polyethylene oxide, has low stability to light and heat. For this reason, when a light-emitting device is used for long hours or used as a high-power light-emitting device, the problem is that the resin causes discoloration, gradually lowering the efficiency of the light-emitting device.

In addition, other characteristics required for the resin of wavelength conversion part where semiconductor ultrafine particles are dispersed in resin include transparency. Therefore, what is important in producing a light-emitting device that can be used on high power for long hours, has high color rendering and gives white color is to stably disperse semiconductor ultrafine particles as individual particles in resin that satisfies all the three characteristics: stability to light, heat resistance and transparency.

Semiconductor ultrafine particles have advantages such as high luminous efficiency and much less deterioration than organic dye, because if they have higher energy than band gap, no limitation is put on excitation wavelengths, the emission lifetime is 100,000 times as short as rare earths and the cycle of absorption and light emission is quickly repeated. This raises the expectation that a highly efficient and long-lived light-emitting device can be attained.

In order not to lower luminous efficiency due to aggregation of such semiconductor ultrafine particles, there have been some attempts to stabilize semiconductor ultrafine particles with a dispersant, carry and fix them in a resin matrix. For example, Nonpatent literature 2 has reported on the method to fix cadmium selenide nanoparticles coated with trioctylphosphine in a polymethacrylate matrix.

However, since hydrocarbon polymer resin used as a matrix has poor resistance to light and heat and also allows water and oxygen to permeate little by little, there has been the problem that fixed semiconductor ultrafine particles gradually deteriorate.
Patent literature 1: Japanese Unexamined Patent Publication No. 11-261114
Patent literature 2: Japanese Unexamined Patent Publication No. 2002-314142
Patent literature 3: Japanese Unexamined Patent Publication No. 2003-160336
Patent literature 4: Japanese Unexamined Patent Publication No. 2003-225900
Patent literature 5: Japanese Unexamined Patent Publication No. 2002-121548
Nonpatent literature 1: R. N. Bhargava, Phys. Rev. Lett., 72, 416 (1994)
Nonpatent literature 2: Jinwook Lee et al, Adv. Mater., 12, No. 15, 1102 (2000)

### DISCLOSURE OF THE INVENTION

### Problem to be Solved by the Invention

The main advantage of the present invention is to provide a wavelength converter useful for a light-emitting device which reduces self-quenching of phosphors and has high luminous efficiency, and a light-emitting device using the same.

Another advantage of the present invention is to provide a wavelength converter wherein the use of semiconductor ultrafine particles having a mean particle size of not more than 20 nm inhibits fluorescence characteristics from deteriorating due to moisture and the semiconductor ultrafine particles are dispersed as individual particles in resin without aggregating, and a light-emitting device using the same.

The other advantage of the present invention is to provide a wavelength converter that has high performance and stability over a long period of time without lowering light-emitting capability of the semiconductor ultrafine particles, and a light-emitting device using the same.

### Means for Solving the Problem

The wavelength converter of the present invention to solve the above problems has the following structure.

(1) A wavelength converter which comprises a plurality of wavelength conversion layers respectively containing, as phosphors, at least one type of semiconductor ultrafine particles having a mean particle size of not more than 20 nm and at least one type of fluorescent substance having a mean particle size of not less than 0.1 μm in a resin matrix

(2) The wavelength converter according to (1), wherein the semiconductor ultrafine particles and the fluorescent substance are dispersed in a resin matrix, unevenly distributed in the form of layers and form a plurality of wavelength conversion layers

(3) The wavelength converter according to (1), wherein each of the semiconductor ultrafine particles is a semiconductor composition consisting of at least two or more elements that belong to the groups I-b, II, III, IV, V and VI of the periodic table.

(4) The wavelength converter according to (1), wherein the band gap energy of the semiconductor ultrafine particles is 1.5 to 2.5 eV.

(5) The wavelength converter according to (2), wherein the matrix is a substantially single resin layer

(6) The wavelength converter according to (1), wherein the surface of the semiconductor ultrafine particles is coated with surface-modifying molecules

(7) The wavelength converter according to (6), wherein the surface-modifying molecules have two or more silicon-oxygen bonds repeated

(8) The wavelength converter according to (6), wherein the surface-modifying molecules form coordinate bonds to the surface of the semiconductor ultrafine particles

(9) The wavelength converter according to (7), wherein the number of silicon-oxygen repeating units of each of the surface-modifying molecules is 5 to 500

(10) The wavelength converter according to (1), wherein the semiconductor ultrafine particles have a mean particle size of 0.5 to 20 nm

(11) The wavelength converter according to (1), wherein the semiconductor ultrafine particles have core-shell structure

(12) The wavelength converter according to (6), wherein each of the surface-modifying molecules has at least one functional group selected from the group consisting of an amino group, a mercapto group, a carboxyl group, an amide group, an ester group, a carbonyl group, a phosphoxide group, a sulfoxide group, a phosphone group, an imine group, a vinyl group, a hydroxy group and an ether group

(13) The wavelength converter according to (12), wherein each of the surface-modifying molecules is provided with two or more side chains having the functional group

(14) The wavelength converter according to (13), wherein a side chain is at least one selected from the group consisting of a methyl group, an ethyl group, a n-propyl group, an iso-propyl group, a n-butyl group, an iso-butyl group, a n-pentyl group, an iso-pentyl group, a n-hexyl group, an iso-hexyl group, a cyclohexyl group, a methoxy group, an ethoxy group, a n-propoxy group, an iso-propoxy group, a n-butoxy group, an iso-butoxy group, a n-pentoxy group, an iso-pentoxy group, a n-hexyloxy group, an iso-hexyloxy group and a cyclohexyloxy group

(15) The wavelength converter according to (1), wherein the semiconductor ultrafine particles have light luminescence capability

(16) The wavelength converter according to (2), wherein the resin matrix is obtained by hardening a liquid unhardened material of a mixture of the semiconductor ultrafine particles and the fluorescent substance

(17) The wavelength converter according to (1), wherein a refractive index is not less than 1.7

(18) The wavelength converter according to (1), wherein the resin matrix is hardened by heat energy

(19) The wavelength converter according to (1), wherein the resin matrix is hardened by light energy

(20) The wavelength converter according to (1), wherein the resin matrix comprises polymer resin containing silicon-oxygen bonds in a main chain

(21) The wavelength converter according to (1), which generates fluorescence having at least two or more intensity peaks in the range of wavelengths of visible light

The light-emitting device of the present invention has the following structure.

(22) A light-emitting device comprising a light-emitting element that is provided on a substrate and emits excitation light, and a wavelength converter that is positioned on the anterior surface of the light-emitting element and converts the excitation light into visible light wherein the visible light is output light, wherein the wavelength converter comprises a plurality of wavelength conversion layers respectively containing, as phosphors, at least one type of semiconductor ultrafine particles having a mean particle size of not more than 20 nm and at least one type of fluorescent substance having a mean particle size of not less than 0.1 μm in a resin matrix

(23) The light-emitting device according to (22), wherein the semiconductor ultrafine particles and the fluorescent substance are dispersed in a resin matrix, unevenly distributed in the form of layers and form a plurality of wavelength conversion layers

(24) The light-emitting device according to (22), wherein the plurality of wavelength conversion layers are disposed so that peak wavelengths of light converted in each wavelength conversion layer can be progressively shorter from the light-emitting element side toward the outside

(25) The light-emitting device according to (22), wherein the plurality of wavelength conversion layers respectively contain phosphors

(26) The light-emitting device according to (22), wherein at least part of band gap energy of the phosphors is smaller than energy generated by the light-emitting element

(27) The light-emitting device according to (22), wherein the wavelength converter comprises at least three wavelength conversion layers and each light converted in the three wavelength conversion layers has a wavelength respectively corresponding to red, green and blue

(28) The light-emitting device according to (22), wherein each of the wavelength conversion layers is composed of a polymer resin thin film containing the phosphors

(29) The light-emitting device according to (22), wherein phosphors contained in the wavelength converter are semiconductor ultrafine particles having a mean particle size of not more than 10 nm

(30) The light-emitting device according to (22), wherein the wavelength conversion layers containing the semiconductor ultrafine particles are disposed on the light-emitting element side and a peak wavelength of output light from the semiconductor ultrafine particles is larger than a peak wavelength of output light from the fluorescent substance

(31) The light-emitting device according to (22), wherein the peak wavelength of output light from the semiconductor ultrafine particles is 500 to 900 nm

(32) The light-emitting device according to (22), wherein the peak wavelength of output light from the fluorescent substance is 400 to 700 nm

(33) The light-emitting device according to (22), wherein the excitation light has a center wavelength of not more than 450 nm

(34) The light-emitting device according to (22), wherein the output light has a peak wavelength of 400 to 900 nm

(35) The light-emitting device according to (22), wherein the resin matrix is a substantially single resin layer

(36) The light-emitting device according to (22), wherein each of the wavelength conversion layers has a thickness of 0.05 to 1.0 mm

(37) The light-emitting device according to (22), wherein the wavelength converter has a thickness of 0.1 to 5.0 mm

(38) The light-emitting device according to (22), wherein the phosphors contained in the plurality of wavelength conversion layers are composed of approximately the same material and are respectively semiconductor ultrafine particles having different mean particle sizes

(39) A light-emitting device comprising a light-emitting element that is provided on a substrate and emits excitation light, and a wavelength converter that is positioned on the anterior surface of the light-emitting element and converts the excitation light into visible light wherein the visible light is output light, wherein the wavelength converter comprises a plurality of wavelength conversion layers respectively containing, as phosphors, at least one type of semiconductor ultrafine particles having a mean particle size of not more than 20 nm and at least one type of fluorescent substance having a mean particle size of not less than 0.1 μm in a polymer resin thin film or a sol-gel glass thin film

A method of producing the wavelength converter of the present invention comprises the steps of:

(a) dispersing at least one type of semiconductor ultrafine particles having a mean particle size of not more than 20 nm and at least one type of fluorescent substance having a mean particle size of not less than 0.1 μm in an unhardened material of resin
(b) molding into sheet-like shape the resin having the semiconductor ultrafine particles and the fluorescent substance dispersed, and dispersing the semiconductor ultrafine particles more on one principal surface side of the molded product, and the fluorescent substance more on the other principal surface side
(c) hardening the sheet after the semiconductor ultrafine particles and particles of the fluorescent substance are dispersed

The other method of producing the wavelength converter of the present invention comprises the step of synthesizing semiconductor ultrafine particles in a liquid phase and allowing silicone-based compounds in the liquid phase to coordinate, each of which is mainly composed of silicon-oxygen bonds and has a functional group selected from the group consisting of an amino group, a carboxyl group, a mercapto group and a hydroxy group, prior to the above-mentioned step (a).

A method of producing the light-emitting device of the present invention comprises the steps of providing a light-emitting element on a substrate and disposing the wavelength converter according to (1) so as to cover the light-emitting element.

### EFFECT OF THE INVENTION

In the wavelength converter according to (1) and (2), a fluorescent substance having a mean particle size of not less than 0.1 μm and semiconductor ultrafine particles having a mean particle size of not more than 20 nm which is smaller than a bulk exciton Bohr radius are used as phosphors, making it possible to emit light highly efficiently and reduce the quantity of particle dispersion in the matrix resin.

Therefore, lowering of luminous efficiency caused by self-quenching can be prevented. For this reason, while ordinary oxide phosphors have low luminous efficiency in long wavelength ultraviolet light and short wavelength visible light (350 nm to 420 nm), semiconductor ultrafine particles can emit light highly efficiently in these ranges. Additionally, since semiconductor ultrafine particles do not have high quantum efficiency in the blue emission range of about 450 nm, a fluorescent substance having high quantum efficiency in the blue emission range and a mean particle size of not less than 0.1 μm, and semiconductor ultrafine particles capable of emitting light highly efficiently outside the blue emission range are used in order to attain good luminous efficiency in broad wavelength ranges.

In the wavelength converter according to (3) and (4), semiconductor ultrafine particles are composed of a specific semiconductor composition and have specific band gap energy, thereby enabling fluorescence in the range of 400 to 900 nm to be generated. Consequently, semiconductor ultrafine particles make it possible to cover a wide range of emission wavelengths, and color rendering can be significantly improved, resulting in a light-emitting device with excellent color rendering.

In the wavelength converter according to (5), since the resin matrix of the wavelength converter is a substantially single resin layer without boundary, light attenuation at the boundary is inhibited, leading to higher efficiency.

In the wavelength converter according to (6) and (7), since the surface of the semiconductor ultrafine particles is coated with surface-modifying molecules, steric hindrance of the surface-modifying molecules can keep particles from coming close to one another.

In the wavelength converter according to (8), since the surface-modifying molecules form coordinate bonds to the surface of the semiconductor ultrafine particles, the semiconductor ultrafine particles are stabilized.

In the wavelength converter according to (9), since the number of silicon-oxygen repeating units of each of the compounds is 5 to 500, the compounds coating the semiconductor ultrafine particles reach sufficient quantity, which makes it possible to fully attain the effect of protecting semiconductor ultrafine particles against moisture. Therefore, fluorescence characteristics of ultrafine particle structure are less deteriorated. In this case, since the quantity of the compounds forming coordinate bonds to the semiconductor ultrafine particles relative to the semiconductor ultrafine particles is sufficient, an ultrafine particle composition can keep stably dispersed in resin (e.g. silicone resin) over a long period of time. Also, since the number of silicon-oxygen repeating units of the compound is not more than 500, viscosity of the compound can be small and therefore the compound can efficiently form coordinate bonds to the semiconductor ultrafine particles.

In the wavelength converter according to (10), since the semiconductor ultrafine particles have a mean particle size of not less than 0.5 nm, the semiconductor ultrafine particles are stabilized, which makes it possible to avoid such problems as small particle size caused by dissolution of semiconductor particles. Moreover, since the mean particle size is not more than 20 nm, the semiconductor ultrafine particles quickly repeat light absorption and light emission, thereby fully attaining the effect of improving fluorescence yield. Therefore, it is possible to produce ultrafine particle structure with high fluorescence yield.

In the wavelength converter according to (11), the semiconductor ultrafine particles have core-shell structure, making it possible to prevent fluorescence quantum efficiency from lowering due to crystal lattice defect on the crystal surface of the core part.

In the wavelength converter according to (12), the compound has a specific functional group and firmly forms coordinate bonds to the semiconductor ultrafine particles, making it possible to obtain stable nanoparticle structure.

In the wavelength converter according to (13), since each of the compounds has two or more side chains having the functional group, the compounds bind to the semiconductor ultrafine particles by each functional group, resulting in stronger binding than the case of one functional group, and stable nanoparticle structure can be produced.

In the wavelength converter according to (14), since a specific group used as the side chains, preferably other side chains than the side chains having the functional group does not absorb visible light and ultraviolet rays, it is possible to obtain ultrafine particle structure having high resistance to light.

In the wavelength converter according to (15), the semiconductor ultrafine particles have light luminescence capability. Therefore, taking advantage of the light luminescence capability, the nanoparticle structure and an LED which converts electric power into light can be combined to obtain a small-sized light-emitting device.

In the wavelength converter according to (16), since the unhardened resin matrix is liquid, even when the wavelength converter is provided on uneven structure, the wavelength converter can conform to unevenness.

In the wavelength converter according to (17), since the resin matrix has a refractive index of not less than 1.7, light having wavelengths converted is efficiently released outside of the wavelength converter, and the percentage of light reflected at the interface between the resin matrix and the air can be reduced.

In the wavelength converter according to (18), since the resin matrix is hardened by heat energy, a light-emitting device can be produced with inexpensive equipment such as a drying machine.

In the wavelength converter according to (19), the resin matrix is hardened by light energy, and therefore, by covering a liquid unhardened resin matrix on a light-emitting element and hardening it by light, a light-emitting device can be produced without having an adverse effect on the light-emitting element due to heat.

In the wavelength converter according to (20), since the resin matrix contains polymer resin mainly composed of silicon-oxygen bonds, it is possible to increase resistance to light, resistance to heat and transparency.

Since the wavelength converter according to (21) generates fluorescence having at least two or more intensity peaks in the range of wavelengths of visible light, high color rendering can be easily attained.

In the light-emitting device according to (22) and (23), as mentioned in the above (1) and (2), semiconductor ultrafine particles having a mean particle size of not more than 20 nm which is smaller than a bulk exciton Bohr radius are used as phosphors, making it possible to emit light highly efficiently.

In the light-emitting device according to (24), based on the knowledge that in self-quenching, short wavelength light emitted from some phosphors is absorbed in other phosphors while long wavelength light is not absorbed, the wavelength converter has the plurality of wavelength conversion layers disposed so that emission wavelength (namely, peak wavelength of light converted in each wavelength conversion layer) can be progressively shorter from the light-emitting element side toward the outside. Therefore, it is possible to reduce self-quenching of phosphors in the wavelength conversion layers and attain high luminous efficiency.

In the light-emitting device according to (25), since the plurality of wavelength conversion layers respectively contain phosphors, it is possible to cover a wide range of emission wavelengths and significantly improve color rendering.

In the light-emitting device according to (26), at least part of band gap energy of the semiconductor ultrafine particles is smaller than energy generated by the light-emitting element. This enables energy generated by the light-emitting element to be efficiently absorbed in the semiconductor ultrafine particles, resulting in better luminous efficiency.

In the light-emitting device according to (27), the wavelength converter comprises at least three wavelength conversion layers and each light converted in the three wavelength conversion layers has a wavelength respectively corresponding to red, green and blue. This makes it possible to cover a wide range of emission wavelengths and significantly improve color rendering.

In the light-emitting device according to (28), since each of the wavelength conversion layers is composed of a polymer resin thin film containing the phosphors, it is possible to inhibit the deterioration of the wavelength conversion layers due to light emitted from the light-emitting element and improve durability.

In the light-emitting device according to (29), since phosphors contained in the wavelength converter are semiconductor ultrafine particles having a mean particle size of not more than 10 nm, it is possible to further increase luminous efficiency and improve the lifetime.

In the light-emitting device according to (30) to (32), the wavelength conversion layers containing the semiconductor ultrafine particles are disposed on the light-emitting element side and a peak wavelength of output light from the semiconductor ultrafine particles is larger than a peak wavelength of output light from the fluorescent substance. Therefore, it is possible to reduce self-quenching of phosphors in the wavelength conversion layers and attain high luminous efficiency.

In the light-emitting device according to (33), since the excitation light has a center wavelength of not more than 450 nm, the light-emitting element has high external quantum efficiency, and the phosphors in the wavelength converter highly efficiently absorb and wavelength-convert primary light from the light-emitting element. Therefore, high light output can be attained.

In the light-emitting device according to (34), the output light has a peak wavelength of 400 to 900 nm, and therefore a light-emitting device with excellent color rendering can be produced.

In the light-emitting device according to (39), each of the wavelength conversion layers is composed of a polymer resin thin film or a sol-gel glass thin film that contain phosphors, and therefore it is possible to inhibit the deterioration of the wavelength conversion layers due to light emitted from the light-emitting element and improve durability.

### PREFERRED EMBODIMENTS FOR PRACTICING THE INVENTION

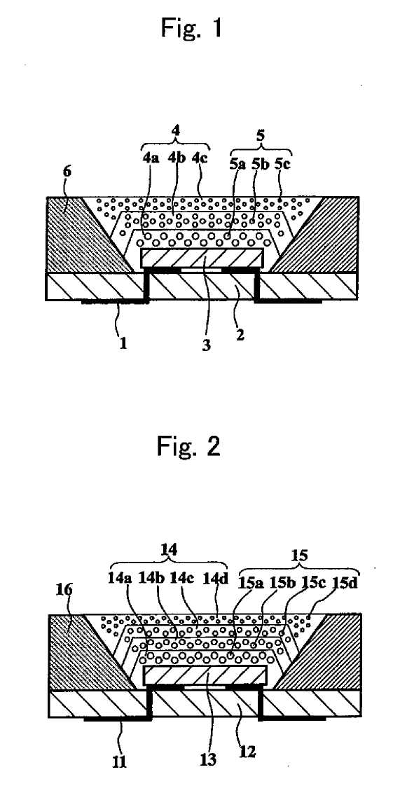

The embodiments of the present invention will be described below with reference to the figures. FIG. 1 is a schematic sectional view showing one embodiment of the light-emitting device of the present invention.

In FIG. 1, the light-emitting device of the present invention comprises a substrate 2 having electrodes 1 formed, a light-emitting element 3 on the substrate 2, emitting light with a center wavelength of not more than 450 nm and made of semiconductor material, and a wavelength converter 4 provided on the substrate 2 so as to cover the light-emitting element 3. The wavelength converter 4 comprises a plurality of wavelength conversion layers 4a, 4b and 4c. The wavelength conversion layers 4a, 4b and 4c respectively contain phosphors 5a, 5b and 5c. Each of the phosphors 5a, 5b and 5c is directly excited by light emitted from the light-emitting element 3, and visible light is produced as converted light. The plurality of converted light is synthesized and taken out as output light.

If necessary, a reflector 6 for reflecting light can be provided on the side surfaces of the light-emitting element 3 and the wavelength converter 4 to make the light running into the side surfaces reflected forward and increase the intensity of output light.

A plurality of wavelength conversion layers 4a, 4b and 4c having different emission wavelengths are disposed so that peak wavelengths of converted light can be progressively shorter from the light-emitting element 3 side toward the outside. For example, in the case of FIG. 1, the wavelength converter 4 comprises three wavelength conversion layers 4a, 4b and 4c, and the wavelength conversion layers 4a, 4b and 4c are disposed so that the peak wavelength of converted light in the wavelength conversion layer 4b can be shorter than the peak wavelength of converted light in the wavelength conversion layer 4a and the peak wavelength of converted light in the wavelength conversion layer 4c can be shorter than the peak wavelength of converted light in the wavelength conversion layer 4b.

The excitation light emitted from the light-emitting element 3 is converted into converted lights A, B and C by the phosphors 5a, 5b and 5c. However, since the converted light A has a longer wavelength than the converted lights B and C, the converted light A does not have enough energy to excite the phosphors 5b and 5c to generate visible light. As a result, self-quenching of phosphors in the wavelength converter 4 can be reduced, and even if the phosphor concentrations in the wavelength conversion layers 4a, 4b and 4c are not raised, high conversion efficiency can be achieved.

Similarly, since the converted light B has a longer wavelength than the converted light C, the converted light B does not excite the phosphors 5c, and self-quenching caused by absorption of the converted light B in the wavelength conversion layer 4c can be reduced.

In contrast, when three types of phosphors having different emission wavelengths are contained in the same wavelength conversion layer as in a conventional light-emitting device, the light emitted from some phosphors is absorbed by other phosphors, and luminous efficiency is not sufficiently increased as the entire light-emitting device.

In the present invention, a plurality of wavelength conversion layers are provided so that emission wavelengths of the wavelength conversion layers can be progressively shorter from the vicinity of the light-emitting element, in other words, so that wavelength conversion layers closer to the light-emitting element have a longer wavelength and wavelength conversion layers further away from the light-emitting element have a shorter wavelength. This makes it possible to inhibit a phenomenon of phosphors absorbing short wavelength converted light. Even if the concentration of the phosphors 5 in the wavelength conversion layers is not raised to increase the content, high conversion efficiency can be achieved. Consequently, it can be expected that high light output is obtained with low power consumption.

The substrate 1 is excellent in heat conductivity and a substrate having large total reflectivity is used. In addition to ceramic material such as alumina and aluminum nitrogen, for example, polymer resin having metal oxide ultrafine particles dispersed is suitably used as the substrate 1.

Preferably, the light-emitting element 3 emits light having a center wavelength of not more than 450 nm, in particular, 380 to 420 nm. The use of excitation light having a wavelength in this range makes it possible to efficiently excite phosphors, increase the intensity of output light and obtain a light-emitting device having higher emission intensity.

The light-emitting element 3 has no special limitation as far as it produces the above center wavelength. However, it is preferable in terms of high external quantum efficiency that the light-emitting element has a structure (not shown in the figures) where an emission layer composed of semiconductor material is provided on the surface of a light-emitting element substrate. This semiconductor material can be exemplified by various semiconductors such as ZnSe and nitride semiconductors (GaN etc.), but as far as emission wavelength is in the above wavelength range, the type of semiconductor material is not specially limited. With the semiconductor material, through a crystal growth method such as metal organic chemical vapor deposition method (MOCVD method) and molecular beam epitaxy method, a laminated structure where an emission layer composed of semiconductor material is provided on a light-emitting element substrate may be formed.

Material of the light-emitting element substrate 2 can be selected, taking into consideration the combination with the emission layer. For example, when an emission layer composed of nitride semiconductor is formed on the surface, material such as sapphire, spinel, SiC, Si, ZnO, ZrB₂, GaN and quartz is suitably used. In order to achieve good mass productivity in forming nitride semiconductors having good crystallinity, use of a sapphire substrate is preferred.

The phosphors 5a, 5b and 5c respectively contained in the wavelength conversion layers 4a, 4b and 4c are directly excited by the light emitted from the light-emitting element 3. The wavelengths of this light are synthesized to cover a wide range of emission wavelengths, resulting in significantly improved color rendering. The peak wavelength of visible light so obtained is preferably 400 to 900 nm, more preferably 450 to 850 nm, most preferably 500 to 800 nm.

Desirably, the wavelength converter 4 generates fluorescence having two or more intensity peaks in the wavelength range of visible light. Further desirably, for example, the wavelength converter 4 comprises a plurality of wavelength conversion layers 4a, 4b and 4c having different conversion wavelengths and the conversion wavelengths consist of wavelengths corresponding to red, green and blue. This makes it possible to cover a wide range of emission wavelengths and further improve color rendering. For example, a light-emitting device shown in FIG. 1 has three-layer structure with three wavelength conversion layers. They are respectively composed of the wavelength conversion layers 4a, 4b and 4c having different conversion wavelengths. Considering color rendering, in this three-layer structure, most preferably, the first wavelength conversion layer 4a has a conversion wavelength peak of 640 nm±10 nm, the second wavelength conversion layer 4b has a conversion wavelength peak of 520 nm±10 nm and the third wavelength conversion layer 4c has a conversion wavelength peak of 470 nm±10 nm.

Preferably, the wavelength conversion layers 4a, 4b and 4e are formed by dispersing the above-mentioned phosphors 5a, 5b and 5c in a polymer resin film or a sol-gel glass thin film. As a polymer resin film or a sol-gel glass thin film, a film that is highly transparent and durable without being easily discolored by heat or light is desirable.

Polymer resin films have advantages of being able to easily disperse phosphors uniformly and carry them and to inhibit light degradation of phosphors. Material is not specially limited and its examples include epoxy resin, silicone resin, polyethylene terephthalate, polybutylene terephthalate, polyethylene naphthalate, polystyrene, polycarbonate, polyethersulfone, acetylcellulose, polyalylate and derivatives of these materials. In particular, light transparency of not less than 95% in the wavelength range of not less than 350 nm is preferred. In terms of heat resistance as well as this transparency, epoxy resin and silicone resin are more suitably used.

Sol-gel glass is exemplified by silica, titania, zirconia and their composites. In sol-gel glass, phosphors may be dispersed alone or metal atoms such as Si, Ti and Zr and phosphors may be bound with organic molecules. Compared to polymer resin films, longer lifetime can be given to products because of high durability against light, particularly, ultraviolet light and high durability against heat. Additionally, sol-gel glass can improve stability and therefore makes it possible to produce a light-emitting device with excellent reliability.

The wavelength converter 4 of the present invention is composed of a polymer resin film or a sol-gel glass film and can be formed through a coating method. As far as it is a general coating method, there is no limitation, but dispenser coating is preferred.

The phosphors 5 contained in the wavelength converter 4 are not especially limited as far as they are composed of material which is excited by light of not more than 450 nm and emits light of 400 to 900 nm. A generally used fluorescent substance can be adopted as the phosphors 5 and its examples include ZnS:Ag, ZnS:Ag, Al, ZnS:Ag, Cu, Ga, Cl, ZnS:Al+In₂O₃, ZnS:Zn+In₂O₃, (Ba,Eu)MgAl₁₀O₁₇, (Sr,Ca,Ba, Mg)₁₀(PO₄)₆Cl₁₇:Eu, Sr₁₀(PO₄)₆Cl₁₂:Eu, (Ba,Sr,Eu)(Mg,Mn)Al₁₀O₁₇, 10(Sr,Ca,Ba, Eu).6PO₄.Cl₂, BaMg₂Al₁₆O₂₅:Eu, ZnS:Cl, Al, (Zn,Cd)S:Cu, Al, Y₃Al₅O₁₂:Tb, Y₃(Al, Ga)₅O₁₂:Tb, Y₂SiO₅:Tb, Zn₂SiO₄:Mn, ZnS:Cu+Zn₂SiO₄:Mn, Gd₂O₂S:Tb, (Zn,Cd)S:Ag, Y₂O₂S:Tb, ZnS:Cu, Al+In₂O₃, (Zn,Cd)S:Ag+In₂O₃, (Zn,Mn)₂SiO₄, BaAl₁₂O₁₉:Mn, (Ba, Sr,Mg)O.aAl₂O₃:Mn, LaPO₄:Ce, Tb, 3(Ba,Mg,Eu,Mn)O.8Al₂O₃, La₂O₃.0.2SiO₂.0.9P₂O₅:Ce, Tb, CeMgAl₁₁O₁₉:Tb, Y₂O₂S:Eu, Y₂O₃:Eu, Zn₃(PO₄)₂:Mn, (Zn,Cd)S:Ag+In₂O₃, (Y,Gd,Eu)BO₃, (Y,Gd,Eu)₂O₃, YVO₄:Eu, La₂O₂S:Eu, Sm, YAG:Ce etc.

Besides the above-mentioned general fluorescent substances, semiconductor ultrafine particles can be used as the phosphors 5, and in particular, semiconductor ultrafine particles having a mean particle size of not more than 20 nm are preferably used. Semiconductor ultrafine particles having a particle size of not more than 20 nm emit a variety of light from red (long wavelength) to blue (short wavelength) by changing the size of nanoparticles and if they have higher energy than band gap, no limitation is put on excitation wavelengths. Moreover, because they have emission lifetime 100,000 times as short as rare earths and quickly repeat a cycle of absorption and light emission, they have characteristic such as very high luminance and less deterioration than organic dye (the number of photons emitted as fluorescence before deterioration is estimated to be about 100,000 times as large as dye). For this reason, use of semiconductor ultrafine particles makes it possible to achieve excellent luminous efficiency and produce a long-lived light-emitting device.

Semiconductor ultrafine particles are excited by light of not more than 450 nm, and as far as they are composed of material emitting light of 400 to 900 nm, there is no limitation. Examples of the material include the following: a simple substance of the elements of the periodic table group 14 such as C, Si, Ge and Sn; a simple substance of the elements of the periodic table group 15 such as P (black phosphorus); a simple substance of the elements of the periodic table group 16 such as Se and Te; a compound composed of a plurality of elements of the periodic table group 14 such as SiC; a compound of the elements of the periodic table group 14 and the elements of the periodic table group 16 such as SnO₂, Sn(II)Sn(IV)S₃, SnS₃, SnS, SnSe, SnTe, PbS, PbSe and PbTe; a compound of the elements of the periodic table group 13 and the elements of the periodic table group 15 such as BN, BP, BAs, AlN, AlP, AlAs, AlSb, GaN, GaP, GaAs, GaSb, InN, InP, InAs and InSb (or a III-V group compound semiconductor); a compound of the elements of the periodic table group 13 and the elements of the periodic table group 16 such as Al₂S3, Al₂Se₃, Ga₂S₃, Ga₂Se₃, Ga₂Te₃, In₂O₃, In₂S₃, In₂Se₃ and In₂Te₃; a compound of the elements of the periodic table group 13 and the elements of the periodic table group 17 such as TlCl, TlBr and TlI; a compound of the elements of the periodic table group 12 and the elements of the periodic table group 16 such as ZnO, ZnS, ZnSe, ZnTe, CdO, CdS, CdSe, CdTe, HgS, HgSe and HgTe (or a II-VI group compound semiconductor); a compound of the elements of the periodic table group 11 and the elements of the periodic table group 16 such as Cu₂O and Cu₂Se; and a compound of the elements of the periodic table group 11 and the elements of the periodic table group 17 such as CuCl, CuBr, CuI, AgCl and AgBr. ZnS, ZnSe, CdS, CdSe and CdTe are suitably used because of their excellent luminescence characteristics. Furthermore, regarding the ratio of semiconductor ultrafine particles and the fluorescent substance, the weight ratio of fluorescent substance:semiconductor ultrafine particles may be 1:0.2 to 5. This can inhibit efficiency reduction due to absorption among semiconductor ultrafine particles, among fluorescent substances and between semiconductor ultrafine particles and fluorescent substances, and therefore a highly efficient light-emitting device can be produced.

The semiconductor ultrafine particles in the present invention may have so-called core-shell structure consisting of an inner core (core) and an outer shell (shell). In some cases, core-shell type semiconductor ultrafine particles are suitable in using exciton absorption and luminescence bands. In this case, forming an energetic barrier by using semiconductor particles whose shell has larger band gap than a core is generally effective. Probably, this is a mechanism which controls the influence of undesirable surface level or the like occurring because of external influence or crystal lattice defect on the crystal surface and the like.

The composition of semiconductor material suitably used for a shell depends on the band gap of core semiconductor crystals, but material whose band gap in bulk condition is not less than 2.0 eV at a temperature of 300K, for example, a III-V group compound semiconductor such as BN, BAs, GaN and GaP, a II-VI group compound semiconductor such as ZnO, ZnS, ZnSe, ZnTe, CdO and CdS, and a compound of the elements of the periodic table group 2 and the elements of the periodic table group 16 such as MgS and MgSe are suitably used.

The semiconductor ultrafine particles in the present invention may be coated with surface-modifying molecules composed of organic ligands. Coating with surface-modifying molecules makes it possible to suppress aggregation of semiconductor ultrafine particles and perform functions of semiconductor ultrafine particles to the full. Examples of surface-modifying molecules include hydrocarbon groups containing an alkyl group having a carbon number of 3 to 20 or so such as a n-propyl group, an isopropyl group, a n-butyl group, an isobutyl group, a n-pentyl group, a cyclopentyl group, a n-hexyl group, a cyclohexyl group, an octyl group, a decyl group, a dodecyl group, a hexadecyl group and an octadecyl group, and an aromatic hydrocarbon group such as a phenyl group, a benzyl group, a naphthyl group and a naphthylmethyl group. Among these, a straight-chain alkyl group having a carbon number of 6 to 16 or so such as a n-hexyl group, an octyl group, a decyl group, a dodecyl group and a hexadecyl group is more preferable. A functional group containing a sulfur atom such as a mercapto group, a disulfide group and a thiophen ring, a functional group containing a nitrogen atom such as an amino group, a pyridine ring, an amide bond and a nitrile group, an acidic functional group such as a carboxyl group, a sulfonic acid group, a phosphonic acid group and a phosphine acid group, a functional group containing a phosphorous atom such as a phosphine group and a phosphine oxide group, a functional group containing an oxygen atom such as a hydroxy group, a carbonyl group, an ester bond, an ether bond and a polyethylene glycol chain, and the like are preferred.

It is preferable that in semiconductor ultrafine particles, silicone-based compounds mainly composed of silicon-oxygen bonds and having a functional group selected from the group consisting of an amino group, a carboxyl group, a mercapto group and a hydroxy group are coordinated on the particle surface, and that the matrix consists of silicone resin mainly composed of silicon-oxygen bonds. The semiconductor ultrafine particles and the fluorescent substance may be dispersed in the silicone resin.

The semiconductor ultrafine particles in the present invention are produced through a general production method. Gaseous phase chemical reaction method such as flame process, plasma process, electrical heating process and laser process, physical cooling method, liquid phase method such as sol-gel method, alkoxide method, coprecipitation method, hot soap method, hydrothermal synthesis method and evaporative decomposition method, and mechanochemical bonding method are used.

The phosphors 5a, 5b and 5c respectively contained in the wavelength conversion layers 4a, 4b and 4c may be a combination of fluorescent substances having different conversion wavelengths, a combination of semiconductor ultrafine particles having different conversion wavelengths, or a combination of fluorescent substances and semiconductor ultrafine particles.

Since the use of the semiconductor ultrafine particles in the present invention makes it possible to obtain an intended emission wavelength just by controlling the particle size, phosphors contained in a plurality of wavelength conversion layers of the present invention can be composed of the same substance. Therefore, the process is more simplified and thereby a light-emitting device can be offered at low price.

Since the semiconductor ultrafine particles in the present invention can change an emission wavelength in the range of 400 to 900 nm by changing the mean particle size, the same material having different mean particle sizes can be used for different wavelength conversion layers.

Preferably, the wavelength converter 4 of the present invention has a thickness of 0.1 to 5.0 mm in terms of conversion efficiency. The thickness range of 0.3 to 1.0 mm is preferable for phosphors having a particle size of several μm. In case of semiconductor ultrafine particles having a particle size of not more than 20 nm, a thickness of 0.1 to 1 mm, in particular, 0.1 to 0.5 mm is preferred. Within this range, light emitted from a light-emitting element can be converted into visible light highly efficiently and furthermore, the converted visible light can be transmitted to the outside highly efficiently.

As far as the wavelength converter 4 is composed of two or more layers, no limitation is put on its layer composition. However, three-layer structure shown in FIG. 1 is preferred in order to improve color rendering, and four-layer structure is expected to further improve color rendering.

For example, FIG. 2 exemplifies the case of four-layer structure. In FIG. 2, a light-emitting element 13 comprising semiconductor material which emits light having a center wavelength of not more than 450 nm is provided on a substrate 12 having electrodes 11 formed, and a wavelength converter 14 is formed so as to cover the light-emitting element 13. The wavelength converter 14 consists of four types of wavelength conversion layers 14a, 14b, 14c and 14d. The wavelength conversion layer 14a closest to the light-emitting element 13 is provided with phosphors 15a having a long wavelength emission peak. The wavelength conversion layers 14b, 14c and 14d are formed so as to respectively contain phosphors 15b, 15c and 15d which have a shorter wavelength emission peak in proportion to the distance from the light-emitting element 13.

In case of four-layer structure, in addition to converted light having a peak wavelength that corresponds to the above wavelengths of red, green and blue used in three-layer structure, phosphors that generate converted light of 590 nm±10 nm are used, thereby enabling color rendering to be enhanced.

Furthermore, if necessary, a reflector 16 to reflect light can be provided on the side surfaces of the light-emitting element 13 and the wavelength conversion layer 14 to reflect the light running into the side surfaces to the front and increase the intensity of output light.

(Production of Wavelength Converter)

A wavelength converter is formed, as mentioned above for example, by stacking and attaching wavelength conversion layers composed of polymer resin thin films or sol-gel glass thin films containing phosphors. Additionally, when there is difference in specific gravity among a plurality of phosphors to be used, the plurality of phosphors are mixed in a resin matrix, and after these phosphors separate in layers according to mean particle size, the resin matrix is hardened. Thereby, a wavelength converter can be obtained.

For example, semiconductor ultrafine particles having a mean particle size of not more than 20 nm and a fluorescent substance having a mean particle size of not less than 0.1 μm are dispersed in a resin matrix. As the time has passed, the both separate into roughly two layers in the resin matrix, and in this condition, the resin matrix is hardened, thereby making it possible to obtain a wavelength converter wherein the semiconductor ultrafine particles and the fluorescent substance are respectively distributed in layers. Since the wavelength converter so obtained is a substantially single resin layer without boundary, it is possible to prevent emission efficiency from decreasing because of spaces on boundary lines.

Semiconductor ultrafine particles and a fluorescent substance used in this embodiment are the same as the aforementioned. Since a wavelength converter to be obtained has two-layer structure, it may be used for a light-emitting device as it is or may be stacked on and attached to another wavelength converter for use.

(Semiconductor Ultrafine Particles with Surface-Modifying Molecules Forming Coordinate Bonds)

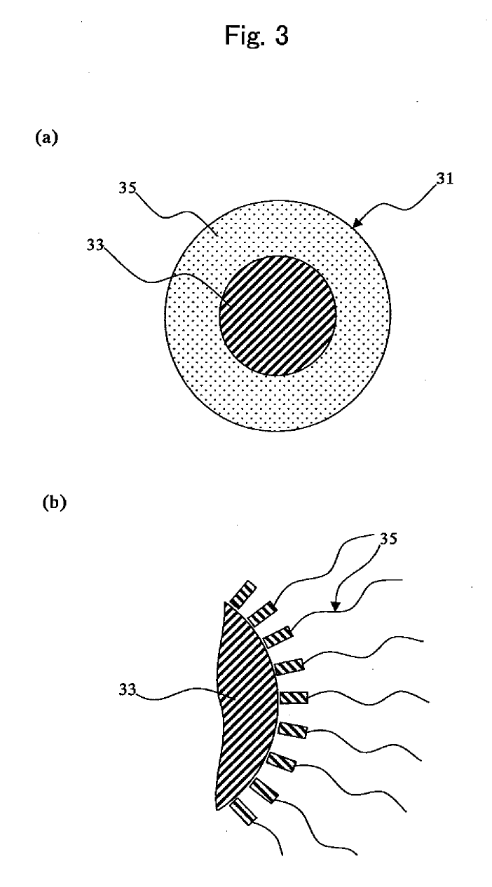

As shown in FIGS. 3 (a) and (b), it is preferable that a semiconductor ultrafine particle 33 in the present invention has structure where its surface is coated with compounds 35 which have two or more silicon-oxygen bonds repeated. In particular, as shown in FIG. 3 (b), it is desirable that the compounds 35 form coordinate bonds to the semiconductor ultrafine particle 33.

Thus, the surface of the semiconductor ultrafine particle 3 is coated with the highly hydrophobic compounds 5 which have structure of repeating two or more silicon-oxygen bonds and thereby it is possible to prevent characteristics of the semiconductor ultrafine particle 3 from deteriorating due to water. Since the compounds 35 have very high affinity for silicone resin, the semiconductor ultrafine particle 33 can be easily dispersed in silicone resin and also bonding force between the semiconductor ultrafine particle 33 and silicone resin can be increased.

In terms of improving hydrophobicity of the compounds 35, it is desirable to form not less than 5, especially not less than 7 silicon-oxygen bonds in the compound 35. On the other hand, by keeping the number of silicon-oxygen bonds not more than 500, it is possible to inhibit the compound 35 from having unnecessarily large size and efficiently coordinate the compounds 35 on the surface of the semiconductor ultrafine particle 3. Particularly, in terms of coordinating more compounds 35 on the surface of the semiconductor ultrafine particle 33, the number of silicon-oxygen repeating units is desirably not more than 300, especially not more than 100. In contrast, when the number of silicon-oxygen bonds is over 500, the compound 35 has very high viscosity, thereby leading to the problem that reactivity decreases and uniform coating becomes impossible in the reaction step of coating the surface of the semiconductor ultrafine particle.

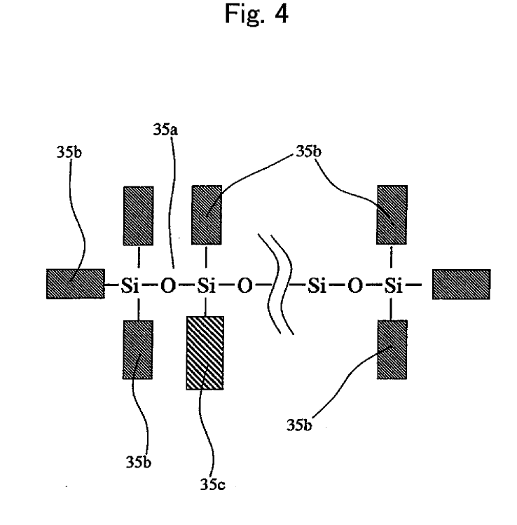

As shown in FIG. 4, the compound 35 comprises a main chain 35a having two or more silicon-oxygen bonds repeated, and a side chain 35b binding to the main chain 35a. In FIG. 4, a side chain 35b without functional group and a side chain 35c with functional group are separately described.

In order to easily bind the semiconductor ultrafine particle 33 and the compound 35 and improve binding force between the both, the side chain 35b desirably comprises a functional group X selected from the group of an amino group, a mercapto group, a carboxyl group, an amide group, an ester group, a carbonyl group, a phosphoxide group, a sulfoxide group, a phosphone group, an imine group, a vinyl group, a hydroxy group and an ether group, as shown in the following formula (a).

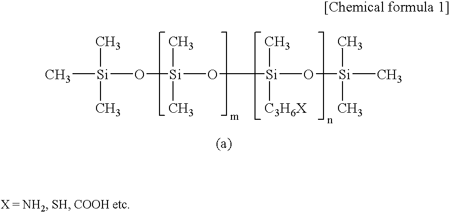

Since the functional group X has an unshared electron pair or a π electron, it works as nucleophilic agent and strongly forms coordinate bonds to the semiconductor ultrafine particle 33, or it strongly forms coordinate bonds to the semiconductor ultrafine particle 33 by electric action of electric charge due to polarization. Therefore, an ultrafine particle structure wherein the compound 35 having the functional group forms coordinate bonds to the semiconductor ultrafine particle 33 can stably maintain the coordinate bonds over a long period of time. In particular, because of strong force of coordinate bond to the semiconductor ultrafine particle 33, an amino group, a mercapto group and a carboxyl group can form an ultrafine particle structure 31 that is stable for the longer term. In addition, a hydroxy group has strong coordinate bonds to an oxide semiconductor. This is because an oxygen atom on the surface of an oxide semiconductor and hydrogen of a hydroxyl group are attracted.

The functional group may bind directly to a silicon atom of the main chain 35a or may bind to a silicon atom through a methylene group or an ethylene group of the side chain 35b.

In terms of improving light resistance and heat resistance of the ultrafine particle structure 31, it is preferable that among side chains in the compound 35, the side chain 35b without functional group which is any of an amino group, a mercapto group, a carboxyl group, an amide group, an ester group, a carbonyl group, a phosphoxide group, a sulfoxide group, a phosphone group, an imine group, a vinyl group, a hydroxy group and an ether group is mainly composed of any or a combination of a methyl group, an ethyl group, a n-propyl group, an iso-propyl group, a n-butyl group, an iso-butyl group, a n-pentyl group, an iso-pentyl group, a n-hexyl group, an iso-hexyl group, a cyclohexyl group, a methoxy group, an ethoxy group, a n-propoxy group, an iso-propoxy group, a n-butoxy group, an iso-butoxy group, a n-pentoxy group, an iso-pentoxy group, a n-hexyloxy group, an iso-hexyloxy group and a cyclohexyloxy group, as shown in the following formula (b).

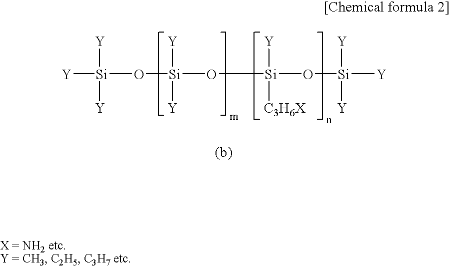

The reason for this is that when the side chain 35b has a functional group such as a phenyl group and a vinyl group to absorb ultraviolet light, this section absorbs light energy, thereby causing efficiency to be lowered and moreover this energy causes damage to this compound. When the side chain 35b consists of a hydrocarbon group and the hydrocarbon group has a long chain, the compound 35 has lower heat resistance compared to the case of short chain.

Preferably, the compound 35 has two or more side chains 35c with functional group. This makes it possible for the compound 35 to firmly form coordinate bonds to the semiconductor ultrafine particle 33 at a plurality of binding points.

As described above, by controlling the structure of the compound 35, the compound 35 can firmly bind to the semiconductor ultrafine particle 33 and also the ultrafine particle structure 31 excellent in water resistance, heat resistance and light resistance can be obtained.

In terms of enabling the wavelength of fluorescence to be adjusted by particle size, it is preferable that the semiconductor ultrafine particle 33 used in the ultrafine particle structure 31 has a mean particle size of 0.5 to 20 nm. By adjusting the particle size of semiconductor ultrafine particles, a light-emitting device with high color rendering can be produced. In contrast, when the semiconductor ultrafine particle 33 has a mean particle size of over 20 nm, even though the particle size is changed, the wavelength of fluorescence hardly changes, and therefore color rendering cannot be adjusted by changing the particle size of the semiconductor ultrafine particle 33. Furthermore, when the semiconductor ultrafine particle 33 has a mean particle size of over 20 nm, it is impossible to attain high fluorescence yield owing to the semiconductor ultrafine particle 33 quickly repeating light absorption and light emission.

Desirably, in terms of preventing aggregation, the semiconductor ultrafine particle 33 has a mean particle size of not less than 1 nm, especially not less than 2 nm. Additionally, it is desirable in order to attain high fluorescence yield that the semiconductor ultrafine particle 33 has a mean particle size of not more than 10 nm, especially not more than 5 nm.

Examples of a method to obtain the semiconductor ultrafine particle 33 having a mean particle size of 0.5 to 20 nm include a production method of forming a reversed micelle with trioctylphosphinoxide and reacting a metal element and a chalcogen element at a temperature of about 300° C. in this micelle.

In terms of enabling production of a light-emitting device having small size and high color rendering, it is preferable that the semiconductor ultrafine particle 33 has light luminescence capability. In terms of excellent fluorescence characteristics, the semiconductor ultrafine particle 33 is preferably composed of a II-IV group compound semiconductor or a III-V group compound semiconductor. In particular, because of high fluorescence quantum efficiency, ZnS, ZnSe, CdS, CdSe and CdTe make it possible to produce an ultrafine particle structure having high fluorescence quantum efficiency.

Furthermore, in terms of obtaining the ultrafine particle structure 31 having high fluorescence quantum efficiency, it is preferable that the semiconductor ultrafine particle 33 has the above-mentioned core-shell structure.

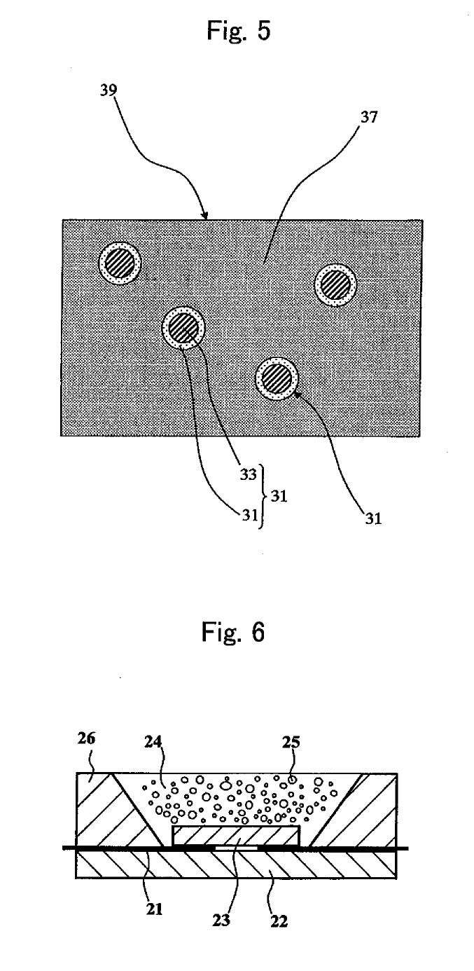

By dispersing the above-mentioned ultrafine particle structures 31 in a resin matrix 37 as shown in FIG. 5, the effect of keeping the ultrafine particle structures 31 from moisture is further enhanced, which makes it possible to more effectively prevent characteristics of the semiconductor ultrafine particle 33 from deteriorating due to moisture. Furthermore, since the ultrafine particle structures 31 can be handled in powdered state and in liquid or solid state, handling capability and storage stability are significantly improved.

FIG. 5 shows the ultrafine particle structure 31 only. Combined with a fluorescent substance having a mean particle size of not less than 0.1 μm, the ultrafine particle structure 31 constitutes a wavelength converter 39.

The resin matrix 37 constituting the wavelength converter 39 is obtained by mixing, in liquid state, the ultrafine particle structure 31 and a resin matrix containing photopolymerizing resin or thermoset resin, for example. In terms of handling, desirably, the resin matrix 37 is hardened into a given shape by heat and light, if necessary.

When the resin matrix 37 to be used is hardened by heat energy, the wavelength converter 39 can be hardened in such inexpensive equipment as a drying machine and a heater block.

In order to obtain a light-emitting device having high adhesion between the wavelength converter 39 and the light-emitting element, it is preferable that the resin matrix 37 is hardened by light energy. When the resin matrix 37 to be used is a type of resin matrix hardened by light energy, an unhardened wavelength converter 39 disposed in liquid state on a light-emitting element can be hardened by light. According to this method, unlike the case of using a thermoset-type wavelength converter 39, the wavelength converter 39 can be hardened without breaking the light-emitting element by heat for hardening. Therefore, the light-emitting element and the unhardened wavelength converter 39 in liquid state can be directly contacted, thereby making it possible to obtain a light-emitting device having high adhesion between the wavelength converter 39 and the light-emitting element.

The use of silicone resin as the resin matrix 37 provides a wavelength converter 39 excellent in translucency and excellent in heat resistance, light resistance and water resistance.

The silicone resin comprises a main chain having silicon-oxygen bonds repeated in its main part and a side chain binding to the silicon atom, and these are cross-linked. When the side chain is a group to absorb ultraviolet light such as a phenyl group and a vinyl group, light absorption occurs in silicone resin. For this reason, it is preferable that silicone resin used in the wavelength converter 39 has a side chain composed of a straight-chain or branched, or cyclic saturated hydrocarbon group. When a saturated hydrocarbon group has a carbon number of over 7, heat resistance is lowered. Therefore, more preferably, the side chain is composed of any of alkyl groups or cycloalkyl groups having a carbon number of 1 to 6 such as a methyl group, an ethyl group, a n-propyl group, an iso-propyl group, a n-butyl group, an iso-butyl group, a n-pentyl group, an iso-pentyl group, a n-hexyl group, an iso-hexyl group or a cyclohexyl group, or composed of a combination of two or more kinds of these.

For a similar reason to this, preferably, the side chain 35b of the compound 35 is composed of any or a combination of a methyl group, an ethyl group, a n-propyl group, an iso-propyl group, a n-butyl group, an iso-butyl group, a n-pentyl group, an iso-pentyl group, a n-hexyl group, an iso-hexyl group, a cyclohexyl group, a methoxy group, an ethoxy group, a n-propoxy group, an iso-propoxy group, a n-butoxy group, an iso-butoxy group, a n-pentoxy group, an iso-pentoxy group, a n-hexyloxy group, an iso-hexyloxy group and a cyclohexyloxy group.

Additionally, use of at least two types of semiconductor ultrafine particles having different composition makes it easy to combine fluorescence having a plurality of different wavelengths and makes it possible to obtain a light-emitting device having high color rendering. For example, combination of cadmium selenide and zinc sulfide enables red and blue lights to be emitted at the same time in a wavelength converter with the same particle size. Therefore, by preparing the ultrafine particle structure 31 with easy-to-make particle size in terms of manufacturing equipment and with several kinds of composition, it is possible to obtain a wavelength converter 39 having high color rendering.

In order to efficiently release light wavelength-converted inside the wavelength converter 39 into the air, the wavelength converter 39 preferably has a refractive index of not less than 1.7. Light emitted in a light-emitting element is conducted to the wavelength converter 39 where the ultrafine particle structure 31 and silicone resin 13 are mixed, wavelength-converted here and then released into the air. When the wavelength converter 39 has a refractive index of less than 1.7, light is reflected at the interface between the wavelength converter 39 and the air, making it difficult to be released into the air. With a wavelength converter molded into a 1 mm-thick film, the refractive index is measured by a refractive index measuring instrument 2010 Prism Coupler manufactured by iPROS.

As mentioned earlier, in order to obtain a white light-emitting device having high color rendering, it is preferable that the wavelength converter 39 generates fluorescence having at least two or more intensity peaks in the range of wavelengths of visible light and in particular, generates fluorescence having three or more intensity peaks in the range of wavelengths of visible light. This makes it possible to obtain white light having high color rendering.

The light-emitting device of the present invention has structure shown in FIG. 1 and FIG. 2. When electric power is supplied to electrodes 1, a light-emitting element 3 emits ultraviolet rays and the light is supplied to the interior of the wavelength converter 39. The ultraviolet rays are converted into visible light by ultrafine particle structures 31 in the interior of the wavelength converter 39, and the converted light is released from the wavelength converter 39 to the outside of the light-emitting device.

In addition, ultrafine particle structures having a plurality of mean particle sizes are contained in the wavelength converter 39, so that output light can have a wide range of spectra of 400 to 900 nm to improve color rendering.

With a view to producing a light-emitting device having good emission efficiency, it is preferable that at least part of band gap energy of the semiconductor ultrafine particles 33 is smaller than energy generated by the light-emitting element 3. When all the band gap energy of the semiconductor ultrafine particles 33 is larger than energy generated by the light-emitting element 3, the semiconductor ultrafine particles 33 cannot absorb light energy generated by the light-emitting element 3, considerably lowering efficiency of the light-emitting device.

The following is detailed description of a method of producing the ultrafine particle structure of the present invention. The ultrafine particle structure 31 shown in FIG. 3 can be produced by mixing a semiconductor ultrafine particle 33 and a compound 35 wherein two or more silicon-oxygen bonds that can form coordinate bonds are repeated, and agitating them on heating.

With a compound mainly composed of an alkyl group and having a functional group as a solvent, the semiconductor ultrafine particle 33 can be produced through a hot soap method, a microreactor method or the like. As the compound mainly composed of an alkyl group, trioctylphosphinoxide, dodecylamine and the like can be used. As the compound wherein two or more silicon-oxygen bonds that can form coordinate bonds are repeated, the above-mentioned can be used. By mixing a semiconductor ultrafine particle 33 and a compound 35 and agitating them on heating, trioctylphosphinoxide or dodecylamine that has formed coordinate bonds to the surface of the semiconductor ultrafine particle 33 is exchanged for the compound 35 and the compound 35 is allowed to form coordinate bonds to the surface of the semiconductor ultrafine particle 33 to obtain the ultrafine particle structure 1. At this time, heating may be carried out if it is needed. When the compound 35 can form coordinate bonds to the surface of the semiconductor ultrafine particle 33 at room temperature, heating is unnecessary.

The unhardened wavelength converter 39 in liquid state can be produced by mixing the ultrafine particle structure 31 with unhardened resin or resin given plasticity by a solvent. As unhardened resin, for example, silicone resin or epoxy resin can be used. The resin may be a type of resin with two liquids mixed for hardening or a type of resin with one liquid for hardening. In case of the type of resin with two liquids mixed for hardening, the ultrafine particle structures 31 may be kneaded respectively in the both liquids, or the ultrafine particle structures 31 may be kneaded in either one of the liquids. Furthermore, as resin given plasticity by a solvent, for example, acrylic resin can be used.

A hardened wavelength converter 39 is obtained by molding an unhardened wavelength converter 39 into film-like shape, for example, through coating, or by running an unhardened wavelength converter 39 into a given mold and hardening it. Examples of a method to harden resin include not only methods to use heat energy or light energy but also methods to volatilize a solvent.

The light-emitting device of the present invention is obtained by disposing the wavelength converter 39 on the light-emitting element 3 provided on a wiring substrate 2. As a method to dispose a wavelength converter 39 composite 39 on the light-emitting element 3, it is possible to dispose a hardened composite 39 on the light-emitting element 3 and it is also possible to dispose an unhardened composite 39 in liquid state on the light-emitting element 3 and subsequently harden and dispose it.

For example, a plurality of the light-emitting devices of the present invention are arranged on a substrate for use. In this case, forming a plurality of electrodes on the substrate beforehand, light-emitting devices can be obtained through connection by a metal brazing filler. Examples of the substrate include a printed board and examples of the metal brazing filler include solder. This makes it possible to produce a group of white light-emitting devices having high power efficiency and long-lasting high color rendering.

The present invention will be described in detail below, referring to examples. It is understood, however, that the present invention is not to be regarded as limited to the following examples.

### EXAMPLE 1

A light-emitting device in FIG. 1 was produced. First, a light-emitting element composed of nitride semiconductor was formed on a light-emitting element substrate composed of sapphire through metal organic chemical vapor deposition method.

As the structure of the light-emitting element, n-type GaN layer which is undoped nitride semiconductor, GaN layer as n-type contact layer having an n-type electrode of Si dope, n-type GaN layer which is undoped nitride semiconductor, GaN layer as barrier layer constituting an emission layer, InGaN layer constituting a well layer and GaN layer as barrier layer were formed as one set on a light-emitting element substrate, and multiquantum well structure wherein the InGaN layer sandwiched by GaN layers was composed of five stacked layers was adopted.

The light-emitting element was mounted in a package wherein an insulating substrate having wiring pattern for disposing a near-ultraviolet LED formed, and a flame-like reflection member surrounding a near-ultraviolet LED were formed. The light-emitting element was mounted on wiring pattern in the package through Ag paste.

Subsequently, filling the inside of the package with silicone resin, the light-emitting element was coated. Moreover, hardening the resin by heating, an internal layer was formed. Silicone resin filling was carried out through a coating method, using a dispenser.

Next, fluorescent substances such as (Sr,Ca,Ba,Mg)₁₀(PO₄)₆C₁₂:Eu, BaMgAl₁₀O₁₇:Eu, Mn and LiEuW₂O₈ and semiconductor ultrafine particles composed of cadmium selenide and gallium nitride were dispersed and mixed in silicone resin composed of dimethyl silicone skeleton under the conditions of Table 1 to prepare phosphor-containing resin paste.

The phosphor-containing resin paste so obtained was applied on a flat substrate with a dispenser and heated on a hot plate at 150° C. for five minutes to prepare a preliminary hardened film (semi-rigid film). Subsequently, this was kept at 150° C. for five hours in a drying machine to prepare phosphor-containing films (wavelength conversion layers) shown in Table 1. This film was put on the upper surface of the internal layer, thereby obtaining a light-emitting device. In a multilayer type wavelength converter, a plurality of the wavelength conversion layers prepared through the above method were formed, with material resin identical to the same silicone resin as the internal layer interposed as adhesive.

Emission efficiency of light-emitting devices consisting of each wavelength converter was measured, using equipment for evaluating luminescence characteristics manufactured by Otsuka Electronics Co., Ltd. The results were shown in Table 1.

The fluorescent substances (Sr,Ca,Ba,Mg)₁₀(PO₄)₆C₁₂:Eu, BaMgAl₁₀O₁₇:Eu, Mn and LiEuW₂O₈ having a mean particle size of not less than 0.1 μm to be used were adjusted through designation at the time of becoming available or pulverization, so as to have various particle sizes.

The semiconductor ultrafine particles composed of cadmium selenide and gallium nitride were prepared through the following method.

7.9 g (0.1M) of Se powder manufactured by Kanto Chemical Co., Inc. was dissolved in 250 g of trioctylphosphine (TOP). This was named Solution 1. Then, 7.6 g (0.1M) of sodium sulfide manufactured by Kanto Chemical Co., Inc. was dissolved in 250 g of trioctylphosphine (TOP). This was named Solution 2.

Next, 1.6 g of cadmium acetate, 9.9 mL of oleic acid and 300 mL of octadecene were mixed, and heated and agitated at 170° C. for two hours under argon flow condition. 29.6 g of selenium metal and 1.5 g of trioctylphosphine (TOP) were added to this solution and agitated at room temperature for 24 hours.

The solution prepared through the above method was agitated at 160° C. to 300° C. for five minutes to synthesize cadmium selenide semiconductor ultrafine particles. By changing reaction temperature, the mean particle size of semiconductor ultrafine particles was controlled. After completing reaction, this solution was cooled down to room temperature. Furthermore, 200 g of toluene was added to the cooled solution and uniformly mixed, and subsequently ethanol was added and an acceleration of 1500 G was attained for ten minutes with a centrifuge to precipitate cadmium selenide particles.

Next, the cadmium selenide particles obtained through the above method was added to a mixed solution of 1.1 g of zinc acetate, 9.9 mL of oleic acid and 300 mL of octadecene, and heated and agitated for two hours at 170° C. under argon flow condition. 12 g of sulfur/1.5 g of trioctylphosphine (TOP) was added to this solution and agitated at 300° C. After completing reaction, the temperature was cooled down to room temperature, 200 g of toluene was added thereto and uniformly mixed, and subsequently ethanol was added and an acceleration of 1500 G was attained for ten minutes with a centrifuge to precipitate cadmium selenide particles having core-shell structure with the surface coated with zinc sulfide.

Cadmium selenide having a mean particle size of 2 nm, 2.9 nm, 4.7 nm and 120 nm was obtained. Also, gallium nitride particles for comparison prepared through a similar method were found to have a mean particle size of 5 nm. The mean particle size of the semiconductor ultrafine particles so obtained was checked by TEM.

Then, 2 g of modified silicone having an amino group as functional group and a methyl group as side chain substituent was added to the semiconductor ultrafine particles so obtained, and heated and agitated at 40° C. for 8 hours in nitrogen atmosphere. Subsequently, after 2 g of toluene was added to the liquid obtained through the above method and agitated, 10 g of methanol was added thereto. After checking that it became clouded, an acceleration of 1500 G was attained for 30 minutes with a centrifuge to precipitate semiconductor ultrafine particles. After that, supernatant solution toluene and methanol solution were removed with a dropper. This step was repeated three times to remove excessive modified silicone, thereby obtaining semiconductor ultrafine particles coated with amino group substitution modified silicone. The state of coating with modified silicone was checked through Fourier transform infrared spectroscopy and further X-ray photoelectron spectroscopy.

The structure of wavelength converters produced with fluorescent substances and semiconductor ultrafine particles that are synthesized thorough the above method and the evaluation results on emission efficiency were shown in Table 1.

TABLE 1

| | | Wavelength converter | | | | | | | | | |
|---|---|---|---|---|---|---|---|---|---|---|---|
| | | First layer | | | | | Second layer | | | | |
| | | | Mean | Band | | | | Mean | Band | | |
| | | | particle | gap | Peak | | | particle | gap | Peak | |
| | | | size | energy | wavelength | Thickness | | size | energy | wavelength | |
| | | Composition | (nm) | (eV) | (nm) | (mm) | Composition | (nm) | (eV) | (nm) | Thickness (mm) |
| | 1 | CdSe | 4.7 | 1.74 | 600 | 0.20 | BaMgAl₁₀O₁₇:Eu, Mn | 3 × 10³ | | 520 | 0.20 |
| | 2 | CdSe | 4.7 | 1.74 | 600 | 0.20 | CdSe | 2.9 | 1.74 | 520 | 0.20 |
| | 3 | CdSe | 4.7 | 1.74 | 600 | 0.20 | BaMgAl₁₀O₁₇:Eu, Mn | 3 × 10³ | | 520 | 0.20 |
| | 4 | CdSe | 10.0 | 1.74 | 700 | 0.20 | CdSe | 2.9 | 1.74 | 520 | 0.20 |
| | 5 | CdSe | 20.0 | 1.74 | 800 | 0.20 | CdSe | 2.9 | 1.74 | 520 | 0.20 |
| | 6 | CdSe | 4.7 | 1.74 | 600 | 0.02 | CdSe | 2.9 | 1.74 | 520 | 0.02 |
| | 7 | CdSe | 4.7 | 1.74 | 600 | 2.00 | CdSe | 2.9 | 1.74 | 520 | 2.00 |
| | 8 | GaN | 5.0 | 3.39 | 350 | 0.20 | CdSe | 2.9 | 1.74 | 520 | 0.20 |
| * | 9 | CdSe | 4.7 | 1.74 | 600 | 0.20 | CdSe | 2.9 | 1.74 | 520 | 0.20 |
| * | 10 | La₂O₂S:Eu | 3 × 10³ | | 630 | 0.20 | BaMgAl₁₀O₁₇:Eu, Mn | 3 × 10³ | | 520 | 0.20 |
| * | 11 | CdSe | 120.0 | 1.74 | 800 | 0.20 | BaMgAl₁₀O₁₇:Eu, Mn | 3 × 10³ | | 520 | 0.20 |
| * | 12 | CdSe | 4.7 | 1.74 | 600 | 0.20 | BaMgAl₁₀O₁₇:Eu, Mn | 0.05 × 10³ | | 520 | 0.20 |

| | | Wavelength converter | | | | | Light- |
|---|---|---|---|---|---|---|---|
| | | Third layer | | | | | emitting |
| | | | Mean | Band | | | device |
| | | | particle | gap | Peak | | Luminous |
| | | | size | energy | wavelength | Thickness | efficiency |
| | | Composition | (nm) | (eV) | (nm) | (mm) | (lm/m) |
| | 1 | CdSe | 0.5 | 1.74 | 450 | 0.20 | 12 |
| | 2 | (Sr,Ca,Ba,Mg)₁₀(PO₄)₆Cl₂:Eu | 6 × 10³ | | 470 | 0.20 | 50 |
| | 3 | (Sr,Ca,Ba,Mg)₁₀(PO₄)₆Cl₂:Eu | 6 × 10³ | | 470 | 0.20 | 48 |
| | 4 | (Sr,Ca,Ba,Mg)₁₀(PO₄)₄Cl₁:Eu | 6 × 10³ | | 470 | 0.20 | 50 |
| | 5 | (Sr,Ca,Ba,Mg)₁₀(PO₄)₆Cl₂:Eu | 6 × 10³ | | 470 | 0.20 | 14 |
| | 6 | (Sr,Ca,Ba,Mg)₁₀(PO₄)₆Cl₂:Eu | 6 × 10³ | | 470 | 0.02 | 12 |
| | 7 | (Sr,Ca,Ba,Mg)₁₀(PO₄)₆Cl₂:Eu | 6 × 10³ | | 470 | 2.00 | 14 |
| | 8 | (Sr,Ca,Ba,Mg)₁₀(PO₄)₆Cl₂:Eu | 6 × 10³ | | 470 | 0.20 | 11 |
| * | 9 | CdSe | 2 | 1.74 | 470 | 0.2 | 9 |
| * | 10 | (Sr,Ca,Ba,Mg)₁₀(PO₄)₆Cl₂:Eu | 6 × 10³ | | 470 | 0.20 | 8 |
| * | 11 | (Sr,Ca,Ba,Mg)₁₀(PO₄)₆Cl₂:Eu | 6 × 10³ | | 470 | 0.20 | 6 |
| * | 12 | (Sr,Ca,Ba,Mg)₁₀(PO₄)₆Cl₂:Eu | 0.05 × 10³ | | 470 | 0.20 | 3 |

Samples marked ‘*’ are out of the scope of the present invention.

In Table 1, since the wavelength converter in a comparative example, Sample No. 9 was prepared by using only semiconductor ultrafine particles, quantum efficiency in the blue range was lowered and the emission efficiency of the light-emitting device became as low as 9 lm/W. In a comparative example, Sample No. 10, since fluorescent substances which were all not less than 0.1 μm were used, emission efficiency in the red range was lowered and the emission efficiency of the light-emitting device became as low as 8 lm/W. Since Sample No. 11 consisted of semiconductor ultrafine particles having a large mean particle size of 120 nm and was out of the scope of the present invention, there was no improvement in quantum efficiency of semiconductor ultrafine particles due to quantum confinement effect and the emission efficiency was 6 lm/W, which was very low. In Sample No. 12, it became apparent that since fluorescent substances to be used had a very small mean particle size of 50 nm, quantum efficiency of fluorescent substances was lowered due to occurrence of surface defect and the emission efficiency of the light-emitting device was 3 lm/W, which was very low.

On the other hand, the light-emitting devices of Sample Nos. 1 to 8 provided with the wavelength converter according to the present invention were found to show emission efficiency of not less than 10 lm/W. In particular, Sample No. 2, Sample No. 3 and Sample No. 4 showed high emission efficiency of not less than 48 lm/W. The peak wavelength of output light of the light-emitting device having the wavelength converter of the present invention used was found to be in the range of 400 to 900 nm.

### EXAMPLE 2

A light-emitting device was produced through the following method. First, a light-emitting element composed of nitride semiconductor was formed on a light-emitting element substrate composed of sapphire through metal organic chemical vapor deposition method.

As the structure of the light-emitting element, n-type GaN layer which is undoped nitride semiconductor, GaN layer as n-type contact layer having an n-type electrode of Si dope, n-type GaN layer which is undoped nitride semiconductor, GaN layer as barrier layer constituting an emission layer, InGaN layer constituting a well layer and GaN layer as barrier layer were formed as one set on a light-emitting element substrate, and multiquantum well structure wherein the InGaN layer sandwiched by GaN layers was composed of five stacked layers was adopted.

The light-emitting element was mounted in a package wherein an insulating substrate having wiring pattern for disposing a near-ultraviolet LED formed, and a flame-like reflection member surrounding a near-ultraviolet LED were formed. The light-emitting element was mounted on wiring pattern in the package through Ag paste. Subsequently, filling the inside of the package with silicone resin, the light-emitting element was coated. Moreover, hardening the resin by heating, an internal layer was formed. Silicone resin filling was carried out, using a dispenser.

Next, semiconductor ultrafine particles and fluorescent substances were mixed in silicone resin, molded into sheet-like shape through die coater method, left at room temperature for 72 hours after sheet molding, and then dried at 150° C. for three hours to prepare the wavelength converter of the present invention. Being left at room temperature for 72 hours, fluorescent substance particles were precipitated due to spontaneous sedimentation, thereby obtaining a wavelength converter which has structure where the part having more semiconductor ultrafine particles dispersed and the part having more fluorescent substance particles dispersed were separated in a sheet cross-sectional direction. The wavelength converter so obtained was mounted on the upper surface of the internal layer to obtain the light-emitting device of the present invention.

The above semiconductor ultrafine particles were synthesized through the following method. First, CdSe semiconductor ultrafine particles were synthesized. At the beginning, 39.5 g (0.5M) of Se powder was dissolved in 1.25 kg of trioctylphosphine (TOP). This was named Solution 1. Next, 26.6 g (0.1M) of cadmium acetate and 0.5 kg of stearic acid were mixed and dissolved at 130° C. After cooling down to not more than 100° C., Solution 1 was added and 0.75 kg of TOP was further added to obtain a precursor liquid. The precursor liquid was heated in an oil bath. Heating was carried out by passing the precursor liquid through a reaction tube part of which was soaked in an oil bath. The heating temperature was 220° C. The reaction time was changed in the range of 0.5 to 15 minutes to control the mean particle size of semiconductor ultrafine particles. At the stage where the precursor liquid came out of the oil bath, it was cooled by being suddenly exposed to room temperature. Thus, semiconductor ultrafine particles having a mean particle size of 2 to 132 nm were obtained.

The fluorescent substances (Sr, Ca, Ba, Mg)₁₀(PO₄)₆C₁₂:Eu, BaMgAl₁₀O₁₇:Eu, Mn and LiEuW₂O₈ having a mean particle size of not less than 0.1 μm to be used were adjusted through designation at the time of becoming available or pulverization, so as to have various particle sizes.

The conditions for producing wavelength converters through the above method and the emission efficiency of light-emitting devices provided with the wavelength converters were shown in Table 2. The emission efficiency of light-emitting devices was evaluated, using equipment for evaluating luminescence characteristics manufactured by Otsuka Electronics Co., Ltd.

TABLE 2

| | | Wavelength converter | | | | | | | | |
|---|---|---|---|---|---|---|---|---|---|---|
| | | | Mean | Peak | | Mean | Peak | | Time of | Luminous |
| | | Particle | particle size | wavelength | | particle size | wavelength | Thickness | being left | efficiency |
| | | composition | (nm) | (nm) | Particle composition | (nm) | (nm) | (nm) | (hr) | (lm/W) |
| | 13 | CdSe | 4 | 550 | (Sr,Ca,Ba,Mg)₁₀(PO₄)₆Cl₂:Eu | 3 × 10³ | 470 | 0.6 | 72 | 54 |
| | 14 | CdSe | 10 | 700 | (Sr,Ca,Ba,Mg)₁₀(PO₄)₆Cl₂:Eu | 3 × 10³ | 470 | 0.6 | 72 | 23 |
| | 15 | CdSe | 20 | 800 | (Sr,Ca,Ba,Mg)₁₀(PO₄)₆Cl₂:Eu | 3 × 10³ | 470 | 0.6 | 72 | 16 |
| | 16 | CdSe | 4 | 550 | (Sr,Ca,Ba,Mg)₁₀(PO₄)₆Cl₂:Eu | 3 × 10³ | 470 | 0.6 | 0.05 | 15 |
| * | 17 | CdSe | 132 | 850 | (Sr,Ca,Ba,Mg)₁₀(PO₄)₆Cl₂:Eu | 3 × 10³ | 470 | 0.6 | 72 | 4 |
| * | 18 | CdSe | 4 | 550 | CdSe | 2 | 470 | 0.6 | 72 | 3 |
| * | 19 | La₂O₂S:Eu | 3 × 10³ | 630 | (Sr,Ca,Ba,Mg)₁₀(PO₄)₆Cl₂:Eu | 3 × 10³ | 470 | 0.6 | 72 | 3 |

In Table 2, since a comparative example, Sample No. 17 consisted of semiconductor ultrafine particles having a large mean particle size of 132 nm and was out of the scope of the present invention, there was no improvement in quantum efficiency of semiconductor ultrafine particles due to quantum confinement effect and the emission efficiency was 4 lm/W, which was very low. Since the wavelength converter in a comparative example, Sample No. 18 was prepared by using only semiconductor ultrafine particles, quantum efficiency in the blue range was lowered and the emission efficiency of the light-emitting device became as low as 3 lm/W. In a comparative example, Sample No. 19, since fluorescent substances which were all not less than 0.1 μm were used, emission efficiency in the red range was lowered and the emission efficiency of the light-emitting device was as low as 3 lm/W.

On the other hand, the light-emitting devices of Sample Nos. 13 to 16 provided with the wavelength converter according to the present invention all showed emission efficiency of not less than 10 lm/w. In particular, Sample No. 13 which was prepared with semiconductor ultrafine particles having a mean particle size of 4 nm showed very high emission efficiency of 54 lm/W.

### EXAMPLE 3

With regard to semiconductor ultrafine particles CdSe used in Example 2, changing the type of surface-modifying molecules, luminescence characteristics of semiconductor ultrafine particles were evaluated.

First, a method of producing CdSe ultrafine particles that are semiconductor ultrafine particles will be described. 7.9 g (0.1M) of Se powder manufactured by Kanto Chemical Co., Inc. was dissolved in 250 g of trioctylphosphine (TOP), and this was named Solution 1. Next, 7.6 g (0.1M) of sodium sulfide manufactured by Kanto Chemical Co., Inc. was dissolved in 250 g of trioctylphosphine (TOP), and this was named Solution 2.

Then, 5.3 g (0.02M) of cadmium acetate manufactured by Kanto Chemical Co., Inc. and 100 g of stearic acid were mixed and dissolved at 130° C. 400 g of trioctylphosphineoxide (TOPO) was added to this solution, heated to 300° C. and dissolved.

The above Solution 1 was added to this solution and reacted under the condition of 300° C. After completing reaction, it was cooled down to room temperature. Furthermore, 200 g of toluene was added to the cooled solution and uniformly mixed, and subsequently ethanol was added and an acceleration of 1500 G was attained for ten minutes with a centrifuge to precipitate cadmium selenide particles. Next, 3.7 g (0.02M) of zinc acetate and 100 g of stearic acid were mixed in the cadmium selenide particles and dissolved at 130° C. 400 g of trioctylphosphineoxide (TOPO) was added to this solution and heated to 300° C., and after Solution 2 was added, the temperature was cooled down to room temperature. 200 g of toluene was added thereto and uniformly mixed, and subsequently ethanol was added and an acceleration of 1500 G was attained for ten minutes with a centrifuge to precipitate cadmium selenide particles having core-shell structure with the surface coated with zinc sulfide.

The cadmium selenide semiconductor ultrafine particles obtained by picking up the precipitation were found to have a mean particle size of 4 nm with a TEM. In addition, when ultraviolet rays were radiated to the cadmium selenide semiconductor ultrafine particles, fluorescent color was yellow. The center wavelength of fluorescent peak was 580 nm.

Next, the cadmium selenide semiconductor ultrafine particles 3 obtained as above were divided into three so that each of the three weighed 2 mg. 2 g of the silicone compound which had, as main chain, silicon-oxygen bonds having any of an amine group, a mercapto group, a carboxyl group, an amide group and a vinyl group shown in the chemical formula (a) as functional group, and had a methyl group as side chain without functional group was respectively added thereto. The number of silicon-oxygen repeating units of the silicone compound was 250 and the number n of side chains with functional group was 5.

This was agitated for 20 hours on heating to 90° C. in nitrogen atmosphere. After finishing agitation, every solution of silicone compound having any of an amino group, a mercapto group and a carboxyl group as functional group came into orange liquid state. While a solution of silicone compound having an amide group or a vinyl group as functional group turned orange, part of cadmium selenide remained as precipitation with no compounds forming coordinate bonds.

Next, excessive silicone compounds which did not form coordinate bonds to cadmium selenide semiconductor ultrafine particles were removed from the semiconductor ultrafine particles. After 2 g of chloroform was added to the above orange liquid and agitated, 10 g of methanol was added and agitated. After checking that this solution became clouded, an acceleration of 1500 G was attained for 30 minutes with a centrifuge to precipitate semiconductor ultrafine particles. Subsequently, supernatant solution chloroform and methanol solution were removed with a dropper. This step was repeated three times to remove silicone compounds and obtain nanoparticle structure.

After the nanoparticle structure was dried in vacuum, two-liquid thermoset-type silicone resin was mixed therein to obtain a liquid unhardened material. This was poured into a 10 mm thick cell for measuring fluorescence, heated and hardened at 80° C. for two hours to obtain hardened wavelength conversion layers. Each of these wavelength conversion layers generated yellow fluorescence when ultraviolet rays were radiated.

Fluorescence intensity of these wavelength conversion layers was measured. The results were shown in Table 3. The fluorescence intensity was measured with PF-5300PC manufactured by Shimadzu Corp.

TABLE 3

| Sample | | Fluorescence |
|---|---|---|
| No. | Functional group | intensity |
| 31 | Amine group | 0.92 |
| 32 | Mercapto group | 0.87 |
| 33 | Carboxyl group | 0.88 |
| 34 | Amide group | 0.54 |
| 35 | Vinyl group | 0.39 |

As apparent from Table 3, each of the samples having an amino group (—NH₂), a mercapto group (—SH), a carboxyl group (—COOH), an amide group (—CONH—) and a vinyl group (—C═C—) as functional group showed high fluorescence intensity.

As comparative example, 0.01 g of cadmium selenide particles having core-shell structure before treated by the above-mentioned silicone compounds was weighed and picked up, and 20 g of toluene was added thereto. On the surface of the cadmium selenide particles, TOPO used as solvent in the step of preparing semiconductor ultrafine particles formed coordinate bonds.

Additionally, the following compound comprising only one silicon-oxygen bond was added to a mixed solution having semiconductor ultrafine particles dispersed in a mixed solution of ethanol and water, followed by drying. A compound for a comparative example is allowed to bind to the surface of the semiconductor ultrafine particles to prepare the semiconductor ultrafine particles for the comparative example. 0.01 g of the semiconductor ultrafine particles for the comparative example was weighed and 20 g of toluene was added thereto.

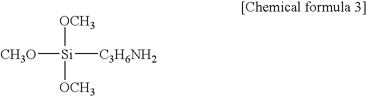

0.01 g of the above nanoparticle structure 1 having an amino group as functional group was weighed and 20 g of toluene was added thereto. The fluorescence intensity of these toluene solutions was measured soon after preparing the toluene solutions and 14 days after preparing the toluene solutions to check a decrease in fluorescence intensity due to moisture in the air. The results are shown in Table 4.

TABLE 4

| | | Fluorescence | Fluorescence |
|---|---|---|---|
| | | intensity | intensity |
| | | soon after | 14 days after |
| | Compound forming | preparing | preparing |
| Sample | coordinate bond to | toluene | toluene |
| No. | semiconductor ultrafine particles | solution | solution |
| *36 | TOPO | 0.90 | 0.70 |
| *37 | Compound having only one | 0.89 | 0.65 |
| | silicon-oxygen bond | | |
| 38 | Compound having silicon-oxygen | 0.92 | 0.92 |
| | bonds repeated | | |
| | (Amine functional group, | | |
| | m = 250, n = 5) | | |

Samples marked ‘*’ are out of the scope of the present invention.

Sample Nos. 36 and 37 in Table 4 are comparative examples out of the scope of the present invention. The fluorescence intensity was 0.9 soon after preparing the toluene solutions, but 14 days later, it turned 0.7 in Sample No. 36 and it turned 0.7 in Sample No. 37, which means a decrease in fluorescence intensity was observed. In addition, Sample No. 38 was obtained by weighing 0.01 g of the ultrafine particle structure 1 prepared in the same manner as Sample No. 31 and adding 20 g of toluene. In this sample, the fluorescence intensity was 0.9 soon after and 14 days after preparing the toluene solution, and a decrease in fluorescence intensity was not observed. The wavelength and intensity of fluorescence were measured with PF-5300PC manufactured by Shimadzu Corp.

Next, using a compound having an amino group as functional group X mentioned in the chemical formula (b), and an ethyl group and a n-propyl group as side chain Y without functional group, the same process as above was performed. At this time, the compound was mixed with cadmium selenide and agitated for 20 hours on heating at 90° C., and then the solution turned orange. In the same manner as above, this was mixed with silicone resin and hardened in a cell. The fluorescence intensity of these wavelength conversion layers was measured. The results are shown in Table 5.

TABLE 5

| Sample | Side chain without | Fluorescence |
|---|---|---|
| No. | functional group | intensity |
| 39 | Methyl group | 0.9 |
| 40 | Ethyl group | 0.9 |
| 41 | Propyl group | 0.9 |

Sample No. 39 is identical to Sample No. 31 in Table 3. Both in Sample No. 40 having an ethyl group as side chain without functional group and Sample No. 41 having a n-propyl group as side chain without functional group, fluorescence intensity was 0.9.

Next, a light-emitting element having a center emission wavelength of 395 nm was mounted on an alumina substrate through flip-chip mounting method. A plurality of wavelength conversion layers were prepared thereon, dispersing ultrafine particle structure wherein compounds having an amine group as functional group and a methyl group as side chain without functional group form coordinate bonds to cadmium selenide semiconductor ultrafine particles, (Sr,Ca,Ba,Mg)10(PO4)6Cl2:Eu having a mean particle size of 6 μm and BaMgAl10O17:Eu having a mean particle size of 3 μm respectively in silicone resin. These wavelength conversion layers were formed so as to cover the light-emitting element, thereby obtaining a light-emitting device. The light-emitting device had luminous efficiency of 50 lm/W.

On the other hand, without using silicone compounds, a mixture of cadmium selenide semiconductor ultrafine particles and silicone resin was formed into a 1 mm thick film to prepare a light-emitting device. It had luminous efficiency of 30 Lm/W.

### BRIEF DESCRIPTION OF THE DRAWINGS

[FIG. 1] This is a schematic cross-sectional view showing one embodiment of the light-emitting device of the present invention.

[FIG. 2] This is a schematic cross-sectional view showing the other embodiment of the light-emitting device of the present invention.

[FIG. 3] (a) is a schematic cross-sectional view schematically showing an example of the nanoparticle structure of the present invention, and (b) is its partially enlarged pattern diagram.

[FIG. 4] This is an illustration showing the molecular structure of a compound used for the nanoparticle structure of the present invention.

[FIG. 5] This is a cross-sectional view schematically showing a composite according to the present invention.

[FIG. 6] This is a schematic cross-sectional view showing an example of the structure of a conventional light-emitting device.

### DESCRIPTION OF REFERENCE NUMERALS

1, 11 . . . Electrode
2, 12 . . . Substrate
3, 13 . . . Light-emitting element
4, 14 . . . Wavelength converter
4a, 4b, 4c, 14a, 14b, 14c, 14d . . . Wavelength conversion layer
5, 5a, 5b, 15a, 15b, 15c, 15d . . . Phosphor
6, 16 . . . Reflector

1. A wavelength converter, comprising a plurality of wavelength conversion layers respectively containing, as phosphors, at least one type of semiconductor ultrafine particles having a mean particle size of not more than 20 nm and at least one type of fluorescent substance having a mean particle size of not less than 0.1 μm in a resin matrix

2. The wavelength converter according to claim 1, wherein the semiconductor ultrafine particles and the fluorescent substance are dispersed in a resin matrix, unevenly distributed in the form of layers and form a plurality of wavelength conversion layers

3. The wavelength converter according to claim 1, wherein each of the semiconductor ultrafine particles is a semiconductor composition consisting of at least two or more elements that belong to the groups I-b, II, III, IV, V and VI of the periodic table

4. The wavelength converter according to claim 1, wherein the band gap energy of the semiconductor ultrafine particles is 1.5 to 2.5 eV

5. The wavelength converter according to claim 2, wherein the resin matrix is a substantially single resin layer

6. The wavelength converter according to claim 1, wherein the surface of the semiconductor ultrafine particles is coated with surface-modifying molecules

7. The wavelength converter according to claim 6, wherein the surface-modifying molecules have two or more silicon-oxygen bonds repeated

8. The wavelength converter according to claim 6, wherein the surface-modifying molecules form coordinate bonds to the surface of the semiconductor ultrafine particles

9. The wavelength converter according to claim 7, wherein the number of silicon-oxygen repeating units of each of the surface-modifying molecules is 5 to 500

10. The wavelength converter according to claim 1, wherein the semiconductor ultrafine particles have a mean particle size of 0.5 to 20 nm

11. The wavelength converter according to claim 1, wherein the semiconductor ultrafine particles have core-shell structure

12. The wavelength converter according to claim 6, wherein each of the surface-modifying molecules has at least one functional group selected from the group consisting of an amino group, a mercapto group, a carboxyl group, an amide group, an ester group, a carbonyl group, a phosphoxide group, a sulfoxide group, a phosphone group, an imine group, a vinyl group, a hydroxy group and an ether group

13. The wavelength converter according to claim 12, wherein each of the surface-modifying molecules is provided with two or more side chains having the functional group

14. The wavelength converter according to claim 13, wherein a side chain is at least one selected from the group consisting of a methyl group, an ethyl group, a n-propyl group, an iso-propyl group, a n-butyl group, an iso-butyl group, a n-pentyl group, an iso-pentyl group, a n-hexyl group, an iso-hexyl group, a cyclohexyl group, a methoxy group, an ethoxy group, a n-propoxy group, an iso-propoxy group, a n-butoxy group, an iso-butoxy group, a n-pentoxy group, an iso-pentoxy group, a n-hexyloxy group, an iso-hexyloxy group and a cyclohexyloxy group

15. The wavelength converter according to claim 1, wherein the semiconductor ultrafine particles have light luminescence capability

16. The wavelength converter according to claim 2, wherein the resin matrix is obtained by hardening a liquid unhardened material of a mixture of the semiconductor ultrafine particles and the fluorescent substance

17. The wavelength converter according to claim 1, wherein a refractive index is not less than 1.7

18. The wavelength converter according to claim 1, wherein the resin matrix is hardened by heat energy

19. The wavelength converter according to claim 1, wherein the resin matrix is hardened by light energy

20. The wavelength converter according to claim 1, wherein the resin matrix comprises polymer resin containing silicon-oxygen bonds in a main chain

21. The wavelength converter according to claim 1, which generates fluorescence having at least two or more intensity peaks in the range of wavelengths of visible light

22. A light-emitting device comprising a light-emitting element that is provided on a substrate and emits excitation light, and a wavelength converter that is positioned on the anterior surface of the light-emitting element and converts the excitation light into visible light wherein the visible light is output light, wherein the wavelength converter comprises a plurality of wavelength conversion layers respectively containing, as phosphors, at least one type of semiconductor ultrafine particles having a mean particle size of not more than 20 nm and at least one type of fluorescent substance having a mean particle size of not less than 0.1 μm in a resin matrix

23. The light-emitting device according to claim 22, wherein the semiconductor ultrafine particles and the fluorescent substance are dispersed in a resin matrix, unevenly distributed in the form of layers and form a plurality of wavelength conversion layers

24. The light-emitting device according to claim 22, wherein the plurality of wavelength conversion layers are disposed so that peak wavelengths of light converted in each wavelength conversion layer can be progressively shorter from the light-emitting element side toward the outside

25. The light-emitting device according to claim 22, wherein at least part of band gap energy of the phosphors is smaller than energy generated by the light-emitting element

26. The light-emitting device according to claim 22, wherein the wavelength converter comprises at least three wavelength conversion layers and each light converted in the three wavelength conversion layers has a wavelength respectively corresponding to red, green and blue

27. The light-emitting device according to claim 22, wherein each of the wavelength conversion layers is composed of a polymer resin thin film containing the phosphors

28. The light-emitting device according to claim 22, wherein phosphors contained in the wavelength converter are semiconductor ultrafine particles having a mean particle size of not more than 10 nm

29. The light-emitting device according to claim 22, wherein the wavelength conversion layers containing the semiconductor ultrafine particles are disposed on the light-emitting element side and a peak wavelength of output light from the semiconductor ultrafine particles is larger than a peak wavelength of output light from the fluorescent substance

30. The light-emitting device according to claim 22, wherein the peak wavelength of output light from the semiconductor ultrafine particles is 500 to 900 nm

31. The light-emitting device according to claim 22, wherein the peak wavelength of output light from the fluorescent substance is 400 to 700 nm

32. The light-emitting device according to claim 22, wherein the excitation light has a center wavelength of not more than 450 nm

33. The light-emitting device according to claim 22, wherein the output light has a peak wavelength of 400 to 900 nm

34. The light-emitting device according to claim 22, wherein the resin matrix is a substantially single resin layer

35. The light-emitting device according to claim 22, wherein each of the wavelength conversion layers has a thickness of 0.05 to 1.0 mm

36. The light-emitting device according to claim 22, wherein the wavelength converter has a thickness of 0.1 to 5.0 mm

37. The light-emitting device according to claim 22, wherein the phosphors contained in the plurality of wavelength conversion layers are composed of approximately the same material and are respectively semiconductor ultrafine particles having different mean particle sizes

38. A light-emitting device comprising a light-emitting element that is provided on a substrate and emits excitation light, and a wavelength converter that is positioned on the anterior surface of the light-emitting element and converts the excitation light into visible light wherein the visible light is output light, wherein the wavelength converter comprises a plurality of wavelength conversion layers respectively containing, as phosphors, at least one type of semiconductor ultrafine particles having a mean particle size of not more than 20 nm and at least one type of fluorescent substance having a mean particle size of not less than 0.1 μm in a polymer resin thin film or a sol-gel glass thin film

39. A method of producing a wavelength converter comprises the steps of:
(a) dispersing at least one type of semiconductor ultrafine particles having a mean particle size of not more than 20 nm and at least one type of fluorescent substance having a mean particle size of not less than 0.1 μm in an unhardened material of resin
(b) molding into sheet-like shape the resin having the semiconductor ultrafine particles and the fluorescent substance dispersed, and dispersing the semiconductor ultrafine particles more on one principal surface side of the molded product, and the fluorescent substance more on the other principal surface side
(c) hardening the sheet after the semiconductor ultrafine particles and particles of the fluorescent substance are dispersed

40. The method of producing a wavelength converter according to claim 39, comprising the step of synthesizing semiconductor ultrafine particles in a liquid phase and allowing silicone-based compounds in the liquid phase to coordinate, each of which is mainly composed of silicon-oxygen bonds and has a functional group selected from the group consisting of an amino group, a carboxyl group, a mercapto group and a hydroxy group, prior to the above-mentioned step (a)

41. A method of producing a light-emitting device comprising the steps of:
providing a light-emitting element on a substrate; and
disposing the wavelength converter according to claim 1 so as to cover the light-emitting element
